(19) United States
(12) Patent Application Publication
(10) Pub. No.: US 2025/0311904 A1
(43) Pub. Date: Oct. 9, 2025

(54) VACUUM INLET VALVE ASSEMBLY WITH MULTIPLE LOCKED POSITIONS FOR A VACUUM HOSE

(71) Applicant: H-P Products, Inc., Louisville, OH (US)

(72) Inventors: Greg A. Calderone, Canton, OH (US); Shawn C. Metz, Louisville, OH (US)

(73) Assignee: H-P Products, Inc., Louisville, OH (US)

(21) Appl. No.: 19/239,503

(22) Filed: Jun. 16, 2025

Related U.S. Application Data
(63) Continuation-in-part of application No. 19/064,342, filed on Feb. 26, 2025.
(63) Continuation of application No. 18/330,906, filed on Jun. 7, 2023, now Pat. No. 12,256,886.
Application No. 18/330,906 is a division of application No. 17/172,197, filed on Feb. 10, 2021, now Pat. No. 11,707,174.
(60) Provisional application No. 62/972,935, filed on Feb. 11, 2020.

(51) Int. Cl. A47L 9/24; A47L 5/38; F16L 5/02; F16L 25/00; F16L 37/14

(52) U.S. Cl. CPC A47L 9/242; A47L 5/38; F16L 5/027; F16L 37/144; F16L 25/0045

(57) ABSTRACT

A valve box assembly of a central vacuum system includes a locking assembly. At least one component of the locking assembly is moveable in a rotational manner or action. Prior to moving the locking assembly to a second locked position, the vacuum hose is moved into the valve box assembly to alter a length of the vacuum hose that extends from the valve box assembly. The length of the vacuum hose that extends from the valve box assembly in the second locked position is shorter than the length of the vacuum hose that extends from the valve box in a first locked position.

### CROSS REFERENCE TO RELATED APPLICATIONS

The present application is a continuation-in-part application of U.S. patent application Ser. No. 19/064,342, filed on Feb. 26, 2025, which is a continuation application of U.S. patent application Ser. No. 18/330,906, filed on Jun. 7, 2023, now U.S. Pat. No. 12,256,886, which is a divisional of U.S. patent application Ser. No. 17/172,197, filed on Feb. 10, 2021, now U.S. Pat. No. 11,707,174, which claims the benefit of U.S. Provisional Application Ser. No. 62/972,935 field on Feb. 11, 2020, the entirety of each of which is incorporated herein by reference.

### TECHNICAL FIELD

The present disclosure relates to inlet valve assemblies of central vacuum cleaning systems. Specifically, the present disclosure relates to a locking sleeve that couples to an inlet valve assembly.

### BACKGROUND

Central vacuum systems may be used in a home, a recreational vehicle, or in a commercial setting. These systems comprise of a main vacuum source usually located in a basement or an adjacent location. The vacuum source is connected to various inlet valves located throughout a building via conduits or tubing. The inlet valves, or valve boxes as they are referred to in the industry, are mounted in a wall, inside a cabinet, or in other structures, by various flanges or brackets. Some examples are shown in U.S. Pat. Nos. 2,953,806, 3,520,725, 4,336,427, 6,459,056, and 7,624,472.

Many vacuum systems use a hose that is slidably moveable and contained within the vacuum conduit and expandable therefrom so that the hose is pulled from the conduit for cleaning an area and then retracted back into the vacuum conduit for storage. Some examples of such systems are shown in U.S. Pat. Nos. 2,953,806, 7,010,829, and 8,001,650. These systems have a debris pickup nozzle which is attached to the end of the hose and is retained in or stored closely to the inlet valve when not in use. These systems include a locking mechanism to secure the hose in an extended position. Other systems include a hose that is stored outside of the conduit in a storage unit near an inlet valve assembly. With these systems, the hose may be removed from the storage unit and pushed into an inlet valve.

Generally, in order to use a central vacuum cleaning system, a hose stored near an inlet valve is removed from storage or a retractable hose stored in a conduit of a central vacuum cleaning system is fully extended or completely removed from the conduit. The locking mechanism located on an inlet valve interacts with a hose cuff located on a hose thereby locking the hose in an extended position to prevent the hose from being removed from an inlet valve. Unfortunately, the locking mechanism may be adapted to locking the hose in only one fully extended position. As a result, all of the hose is removed from the conduit and placed on the floor the user is vacuuming which may cause a user to trip over the hose. If a user wants to extend less than all of the hose from the inlet valve assembly, the locking mechanism will not lock the hose in place. Thus it is desirable to provide a locking mechanism that locks the hose in place at different lengths.

For example, U.S. Pat. No. 7,010,829 uses a flexible sleeve and a band clamp disposed in the valve housing connected to the system vacuum pipe through the vacuum pipe connection port. The vacuum hose passes through the flexible sleeve before exiting the valve assembly. The flexible sleeve is encircled by a clamp band which can be tightened or loosened by the operator moving the clamp lever which opens and closes clamp. The clamp band correspondingly compresses, i.e., radially deforms, or relaxes the flexible sleeve radially. When the flexible sleeve is deformed, i.e., compressed radially around the radially outer surface of the vacuum hose and the hose sock purportedly forms a seal forcing the air to flow into the tool end of the vacuum hose. Despite the clamp band, the flexible sleeve of U.S. Pat. No. 7,010,829 has been determined to cause the hose sock that surrounds the hose to bunch and make it difficult for the hose to be moved relative the vacuum pipe into and out of the connection port. Thus what is needed is an improved device that eliminates this flexible sleeve to solve the problem associated with hose sock bunching but still be able to form as seal with the hose sock as the hose is moved into and out of the vacuum conduit or pipe. Further, an improved locking subassembly is needed for the end of the hose to connect with valve box assembly in combination with an improved different locking subassembly that can seal along an intermediate length of the hose without bunching the sock that surrounds the hose.

### SUMMARY

Currently, retractable hose assemblies of a central vacuum system may be slid into a fully extended position in order to lock the hose assembly to an inlet valve assembly in order to use the central vacuum system. As a result, all of the hose is removed or extended from a conduit in communication with the inlet valve assembly and placed on the floor of a room a user is vacuuming. Thus, there is a continuous need for a locking mechanism that allows a user to retract less than all of the hose assembly from the inlet valve assembly when a user would like to use the central vacuum system. To address this continuing need, the present disclosure provides a locking assembly that is capable of locking a hose assembly to an inlet valve assembly at various positions or multiple different locked positions. The locking assembly includes at least two different locking subassemblies to secure a vacuum hose assembly to the valve box assembly of the central vacuum system at various positions. As such, aspects of the present disclosure relate to an improved locking assembly that secures a hose assembly to an inlet valve assembly at various positions.

In one aspect, an exemplary embodiment of the present disclosure may provide a locking subassembly for a valve box assembly in a central vacuum system, the locking subassembly comprising: a cam track that defines at least one slot in an upper end thereof; a variable diameter split ring C-shaped clamp including at least one boss that is received within the at least one slot of the cam track; wherein the variable diameter split ring C-shaped clamp varies its diameter in response to a cam action imparted by the at least one slot when the cam track is rotated about an axis. This exemplary embodiment or another exemplary embodiment may further include an actuator that is generally annular in shape, wherein the actuator includes a lever at a lower end thereof and defines at least one recess in an upper end thereof; wherein the cam track is a cam track ring that is generally annular in shape, wherein the cam track ring includes at least one downward projection that is received in the at least one recess of the actuator; and wherein the at least one boss on the variable diameter split ring C-clamp projects radially outward from a perimeter thereof.

In another aspect, an exemplary embodiment of the present disclosure may provide a valve box assembly of a central vacuum system having a locking assembly to selectively secure a vacuum hose at various lengths relative to the valve box assembly of the central vacuum system, wherein the locking assembly comprises: a first locking subassembly comprising at least one moveable pin; a different second locking subassembly comprising a variable diameter split ring clamp; wherein when the first locking subassembly and the different second locking subassembly are both in an unlocked position, the vacuum hose freely extends and retracts relative to the valve box assembly; wherein when the first locking subassembly is in a first locked position, the at least one moveable pin couples to an end of the vacuum hose and locks the vacuum hose relative to the valve box assembly; wherein when the different second locking subassembly is in a second locked position, the variable diameter split ring clamp couples to an intermediate length of the vacuum hose and locks the vacuum hose relative to the valve box assembly; wherein prior to moving the locking assembly to the second locked position, the vacuum hose is moved into the valve box assembly to alter a length of the vacuum hose that extends from the valve box assembly; and wherein the length of the vacuum hose that extends from the valve box assembly in the second locked position is shorter than the length of the vacuum hose that extends from the valve box in the first locked position.

This exemplary embodiment or another exemplary embodiment may further provide that the different second locking subassembly further comprises: an annular member defining at least one slot; and at least one boss on the variable diameter split ring clamp, wherein the at least one boss is disposed within the at least one slot.

This exemplary embodiment or another exemplary embodiment may further provide that the at least one boss extends from a perimeter of the variable diameter split ring clamp.

This exemplary embodiment or another exemplary embodiment may further provide that the at least one boss moves within the at least one slot in response to a rotation of the annular member that imparts a cam action to the variable diameter split ring clamp.

This exemplary embodiment or another exemplary embodiment may further provide that the different second locking subassembly further comprises: three slots defined in the annular flange, wherein the at least one slot is one of the three slots; three bosses extending from the perimeter of the variable diameter split ring clamp, wherein the at least one boss is one of the three bosses; wherein the three bosses are disposed within the three slots, respectively.

This exemplary embodiment or another exemplary embodiment may further provide that the different second locking subassembly further comprises a lever that is coupled with the annular flange, wherein rotation of the handle causes the rotation of the annular flange. This exemplary embodiment or another exemplary embodiment may further provide that rotation of the annular flange causes the at least one boss to slide in the at least one slot, wherein movement of the boss causes the variable diameter split ring clamp to vary its diameter.

This exemplary embodiment or another exemplary embodiment may further provide that the variable diameter split ring clamp has a maximum diameter when a lever coupled to the annular flange is in an unlocked position, wherein movement of the lever to the second locked position causes the diameter of the variable diameter split ring clamp to be reduced, wherein the reduced diameter causes the variable diameter split ring clamp to lock onto the hose.

This exemplary embodiment or another exemplary embodiment may further provide that the different second locking subassembly further comprises an actuator that is annular in shape, wherein a lever is integrally formed as part of the actuator and extends radially outward therefrom. This exemplary embodiment or another exemplary embodiment may further provide that the actuator defines at least one recess that is arcuate in shape. This exemplary embodiment or another exemplary embodiment may further provide that the different second locking subassembly further comprises a downward projection that extends from the annular flange, wherein the downward projection is received within the at least one recess. This exemplary embodiment or another exemplary embodiment may further provide that the actuator is coupled with the annular flange to cause the actuator and the annular flange to rotate in unison in response to movement of the lever. This exemplary embodiment or another exemplary embodiment may further provide that rotation of the annular flange causes the at least one boss to slide in the at least one slot to thereby vary the diameter of the variable diameter split ring clamp, wherein movement of the handle from a first position to a second position causes the different second locking subassembly to move from the unlocked position to the second locked position, wherein the diameter of the split ring is reduced in the second locked position and the diameter of the split ring clamp is maximum in the unlocked position.

This exemplary embodiment or another exemplary embodiment may further provide that the different second locking subassembly further comprises a lever that is rotatable about a central axis that is concentric and coaxial with a center axis of the vacuum hose within the valve box assembly. This exemplary embodiment or another exemplary embodiment may further provide that a rotational action of the lever is operatively coupled to the variable diameter split ring clamp such that rotation of the lever causes the second locking subassembly to move from an unlocked position to the second locked position to couple to the intermediate length of the vacuum hose and not the end of the vacuum hose.

This exemplary embodiment or another exemplary embodiment may further provide that the different second locking subassembly further comprises a spiral projection extending radially inward on the split ring clamp, wherein the spiral projection is positioned between ribs on the hose when the second locking subassembly is in the second locked position.

This exemplary embodiment or another exemplary embodiment may further provide that the variable diameter split ring clamp comprises: a C-shaped clamp body; and a C-shaped seal that is positioned atop the C-shaped clamp body.

This exemplary embodiment or another exemplary embodiment may further provide that the variable diameter split ring clamp comprises: a first end and a second end defining a space therebetween when the variable diameter split ring clamp is unstressed in the unlocked position; and a base that defines the second end that remains in a fixed position as the diameter of the split ring clamp is varied.

### BRIEF DESCRIPTION OF THE SEVERAL VIEWS OF THE DRAWINGS

A sample embodiment of the disclosure is set forth in the following description, is shown in the drawings and is particularly and distinctly pointed out and set forth in the appended claims. The accompanying drawings, which are fully incorporated herein and constitute a part of the specification, illustrate various examples, methods, and other example embodiments of various aspects of the disclosure. It will be appreciated that the illustrated element boundaries (e.g., boxes, groups of boxes, or other shapes) in the figures represent one example of the boundaries. One of ordinary skill in the art will appreciate that in some examples one element may be designed as multiple elements or that multiple elements may be designed as one element. In some examples, an element shown as an internal component of another element may be implemented as an external component and vice versa. Furthermore, elements may not be drawn to scale.

FIG. 1 is a cross sectional view of a valve box assembly with a locking sleeve coupled to a hose assembly of a central vacuum system.

FIG. 2 is a perspective view of the locking sleeve shown in FIG. 1.

FIG. 3 is an exploded perspective view of the locking sleeve shown in FIG. 2.

FIG. 4 is a top plan view of the locking sleeve shown in FIG. 2.

FIG. 5 is a cross sectional view of the locking sleeve shown in FIG. 4 taken along the line 5-5 where the locking sleeve is in a first position.

FIG. 6 is a cross sectional view of the locking sleeve shown in FIG. 5 taken along the line 6-6 with a hose assembly of a central vacuum system.

FIG. 7 is another cross sectional view of the locking sleeve shown in FIG. 4 taken along the line 5-5 where the locking sleeve is in a second position.

FIG. 8 is a cross sectional view of the locking sleeve shown in FIG. 7 taken along the line 8-8 coupled to a hose cuff of a hose assembly of a central vacuum system.

FIG. 9 is another cross sectional view of the locking sleeve shown in FIG. 4 taken along the line 5-5 where the locking sleeve is in a third position.

FIG. 10 is a cross sectional view of the locking sleeve shown in FIG. 9 taken along the line 10-10 coupled to a hose of a hose assembly of a central vacuum system.

FIG. 11 is an elevational cross sectional view of another embodiment of a valve box assembly with a locking assembly to selectively secure a vacuum hose at various lengths relative to the valve box assembly of the central vacuum system.

FIG. 12 is an enlarged elevational cross sectional view of the region labeled “SEE FIG. 12” in FIG. 11.

FIG. 13 is an elevational cross sectional view taken along line 13-13 in FIG. 11.

FIG. 14 is a top, front, first side perspective view of a retaining member that is part of the locking assembly that connects to the valve box assembly.

FIG. 15 is a bottom, front, first side perspective view of the retaining member.

FIG. 16 is a top, front perspective view of an actuator that is part of the locking assembly.

FIG. 17 is a bottom, front perspective view of the actuator.

FIG. 18 is a top plan view of the actuator.

FIG. 19 is a perspective view of a foam seal ring.

FIG. 20 is a perspective view of an O-ring seal.

FIG. 21 is a top perspective view of a cam track ring that is part of the locking assembly.

FIG. 22 is a bottom perspective view of the cam track ring.

FIG. 23 is a top plan view of the cam track ring.

FIG. 24 is a top perspective view of a clamp that is part of the locking assembly.

FIG. 25 is a bottom perspective view of the clamp.

FIG. 26 is a top plan view of the clamp.

FIG. 27 is an exploded perspective view of the clamp and the clamp seal.

FIG. 28 is a top perspective view of a pin housing that is part of the locking assembly.

FIG. 29 is a bottom perspective view of the pin housing.

FIG. 30 is an exploded perspective view of some components of the locking assembly.

FIG. 31 is an exploded perspective view of some other components of the locking assembly.

FIG. 32 is an operational top view of the clamp prior to installation on the cam track ring.

FIG. 33 is an operation top view of the clamp installed on the cam track ring.

FIG. 34 is an operational cross section view of the hose being moved through the locking assembly.

FIG. 35A is an operational top view of the actuator beginning to rotate that will cause the cam track ring to rotate and move the clamp to reduce its diameter.

FIG. 35B is an operation top view of the actuator having rotated to move the cam track ring that reduces the diameter of the clamp in order to lock and seal along an intermediate length of the hose.

FIG. 36 is an operational cross sectional view depicting the clamp and clamp seal locked onto an intermediate length of the hose.

Similar numbers refer to similar parts throughout the drawings.

### DETAILED DESCRIPTION

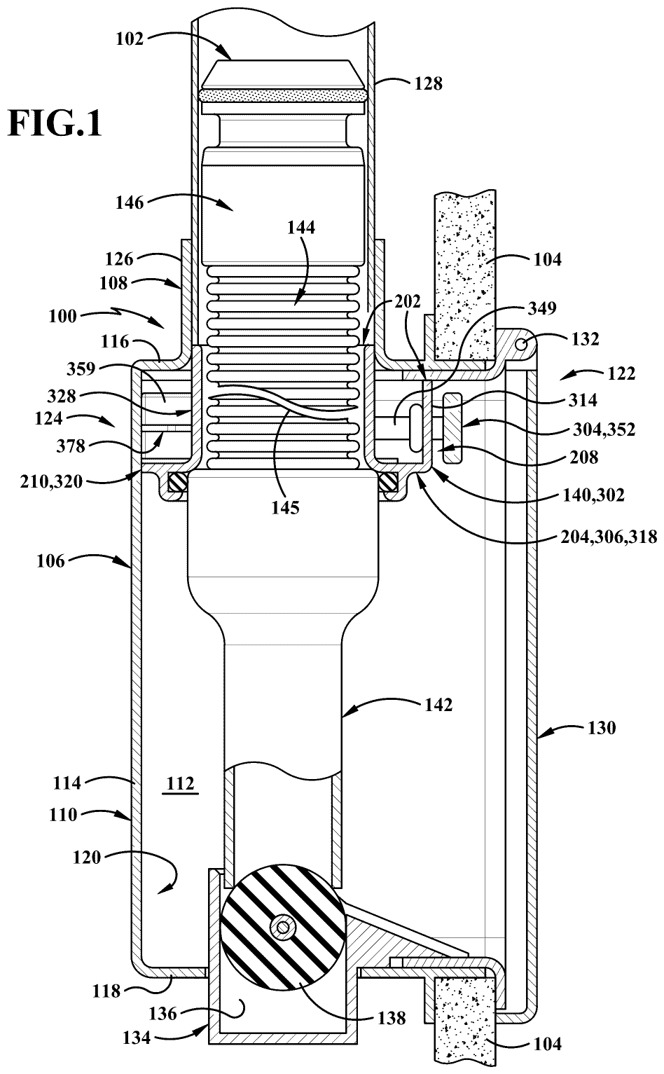

FIG. 1 illustrates a valve box assembly or valve box 100 and a hose assembly 102. The valve box 100 may be attached wall stud and accessible through an opening formed in an attached wall board 104, such as drywall used in a usual home construction. Valve box 100 can be used in various types of constructions.

Valve box 100 includes a main body or housing indicated generally at 106, formed by an upper portion 108 and a lower portion 110. Lower portion 110 is formed by a pair of side walls 112, a rear wall 114, a top wall 116 and a bottom wall 118. The side walls 112, the rear wall 114, the top wall 116, and the bottom wall 118 define an interior chamber 120, a front or outer end opening 122, and a rear end 124. Lower portion 110 preferably will have a rectangular shape as shown in FIG. 1. The upper portion 108 includes a cylindrical coupler 126 that slidably receives a conduit 128 that is connected to a vacuum source. The coupler 126 and the conduit 128 have a frictional interference fit or a fixed connection between them that helps retain the conduit 128 within the coupler 126.

An outer closure door 130 is pivotally mounted adjacent to top wall 116 of housing 106 for opening and closing front end opening 122 in order to conceal interior chamber 120 of lower portion 110 and to provide an attractive faceplate for valve box 100 when mounted to the wall board 104. Door 130 is pivotably mounted with respect to housing 106 by a pivot pin 132. A bottom bracket 134 extends from the bottom wall 118. The bottom bracket 134 forms a channel 136. A ball 138 rests within the channel 136.

The hose assembly 102 includes a debris pickup nozzle handle 142, a flexible hose 144, and a hose cuff 146. The flexible hose 144 is coupled to the debris pickup nozzle handle 142 and the hose cuff 146. The hose 144 is shown with broken line 145 which represents that hose 144 may be of any length. The hose cuff includes a first opening that is in open communication with the conduit 128 and a second opening that is in open communication with a first opening the hose 144. The hose 144 incudes a second opening that is in open communication with a first opening of the debris and pickup nozzle handle 142. The debris and pickup nozzle handle 142 includes a second opening that intakes debris when a central vacuum is in operation. When the hose assembly 102 is in a stored position (FIG. 1) the debris pickup nozzle handle 142 rests upon the ball 138, an end of the debris pickup nozzle handle 142 rests upon the locking sleeve 140 and the hose 144 extends through the locking sleeve 140 into the conduit 128.

In one particular embodiment, the hose assembly 102 interfaces with both a primary valve and a multiplicity of secondary inlet valves. Typically, when a central vacuum cleaning system has both primary and secondary inlet valves, the primary valve is a valve that stores a retractable hose assembly 102 (i.e., valve box 100). As such, the vacuum hose assembly 102 may be stored behind or within wall board 104 of the structure. This enables the hose assembly 102 to be extracted or retracted relative to the primary inlet valve. When the hose assembly 102 is in a retracted and stored position, either within or behind a wall, the debris pickup nozzle handle 142 of the hose assembly 102 may be extracted from the valve box 100. Then, the hose assembly 102 may be disconnected from the primary valve. Once the hose assembly 102 is disconnected, a user may carry the hose to another location within the structure to connect the hose assembly 102 with a secondary inlet valve.

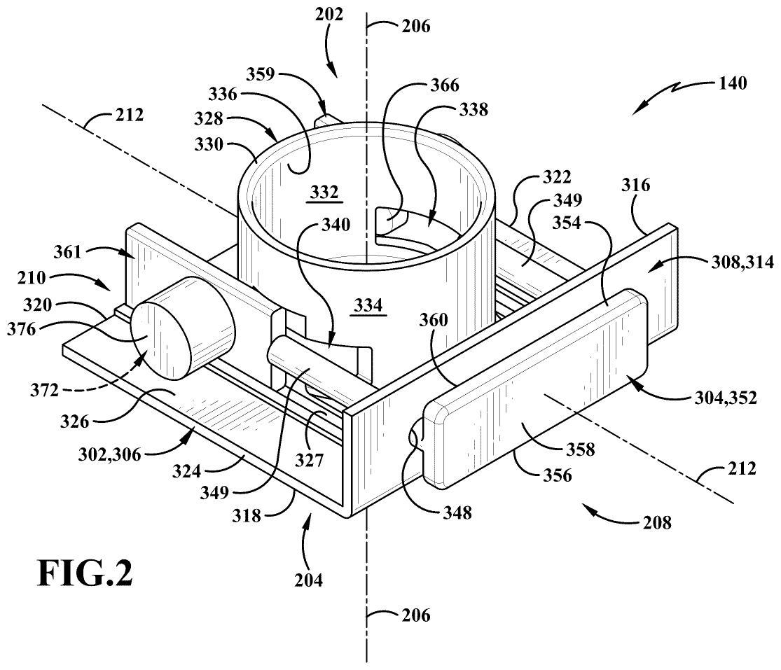

FIG. 2 depicts the locking sleeve 140. The locking sleeve 140 includes a first end 202, a second end 204 opposite the first end 202, a central vertical axis 206 between the first end 202 and the second end 204, a first side 208, a second side 210 opposite the first side 208, and a central horizontal axis 212 between the first side 208 and the second side 210. Some portions of the locking sleeve 140 will be described relative to the central vertical axis 206 or the central horizontal axis 212 and may be used in conjunction with the terms circumferential, or radial, relative to the central vertical axis 206 or the central horizontal axis 212.

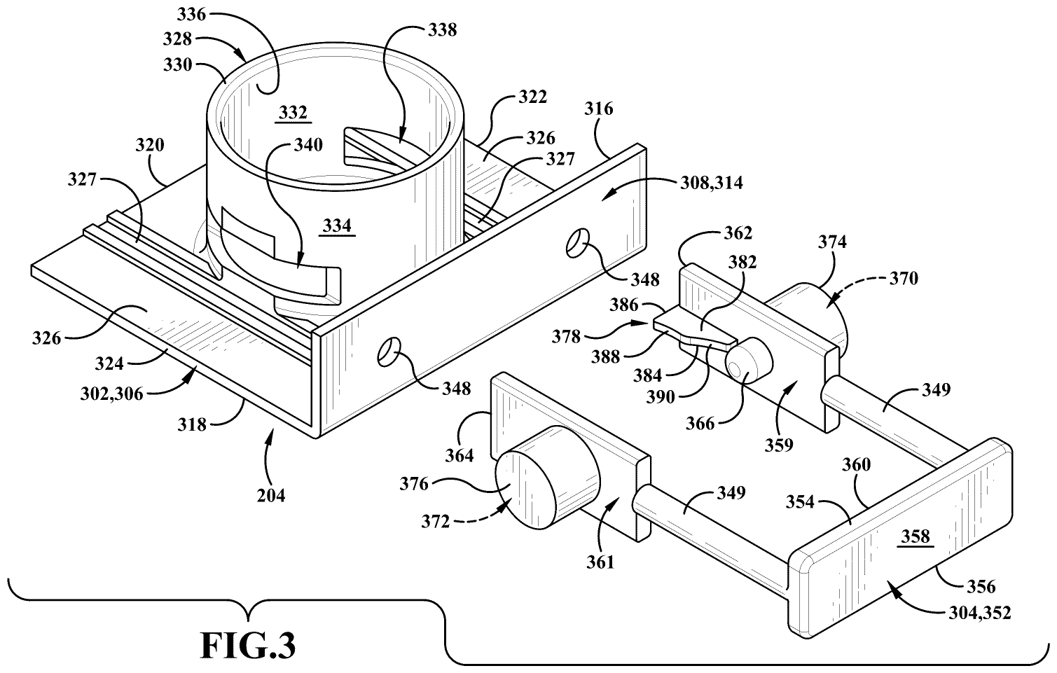

FIG. 3 further depicts the locking sleeve 140. The locking sleeve 140 includes a locking mechanism housing 302 and a slidable locking mechanism 304. The locking mechanism housing 302 includes a horizontal planar first wall 306 and a vertically planar second wall 308. The first wall 306 extends horizontally relative to the vertical axis 206. When the locking sleeve 140 is installed in the valve box 100 (FIG. 1), the first wall 306 is adjacent or may abut the top wall 116. Surface 318 faces the bottom wall 118, the surface 314 faces the front end opening 122, the edge 320 abuts the rear wall 114, and a first side edge 322 and a second side edge 324 abut or are adjacent the side walls 112. Surface 314 faces away from the central vertical axis 206. Surface 316 is opposite the surface 314 and faces toward the central vertical axis 206.

Surface 318 extends from the surface 314 to the edge 320 and extends between the edge 322 and edge 324. Surface 314 extends longitudinally relative to the central vertical axis 206 from edge 322 to edge 324. Surface 326 extends from the surface 316 to edge 320 between edge 322 and edge 324. Surface 326 of the locking mechanism housing 302 defines two grooves 327. The two grooves 327 extend from edge 320 to surface 316 parallel to the central horizontal axis 212. The two grooves 327 have a width complementary to a width of apportion of the slidable locking mechanism 304. As a result, the slidable locking mechanism 304 nests and slides within the two grooves 327 when the slidable locking mechanism 304 is installed in the locking mechanism housing 302.

Surface 326 is generally perpendicular to the central vertical axis 206. Surface 314 and surface 316 are planar from the first end 202 towards the second end 204. However, in another embodiment, the surfaces 314, 316 may slope downward from the first end 202 towards the second end 204 and inward toward the central vertical axis 206.

The locking mechanism housing 302 further includes a cylindrical coupler 328. The coupler 328 extends longitudinally from the second surface 326 to an annular surface 330. The coupler defines a first surface 332 and a second surface 334 opposite the first surface 332. The first surface 332 and the second surface 334 extend circumferentially around and generally parallel to central vertical axis 206. The first surface 332 faces toward the central vertical axis 206 and the second surface 334 faces away from the central vertical axis 206. The first surface 332 extends longitudinally relative to the central vertical axis 206 from the annular surface 330 to the first surface 318 and defines a bore 336. When the locking sleeve 140 is installed in the valve box 100, the coupler 126 of the valve box 100 slidably receives the coupler 328 of the locking mechanism housing 302. The coupler 126 and the coupler 328 have a frictional interference fit between them that helps retain the coupler 328 within the coupler 126. Alternatively, the coupler 328 may be glued or mechanically attached to the coupler 126. Furthermore, when installed in the valve box 100, the annular surface 330 of the coupler 328 abuts the conduit 128. The hose assembly 102 extends from the conduit 128, through the bore 336 of the coupler 328 and into the chamber 120 of the valve box 100. The coupler 328 further defines a first slot 338 and a structurally identical second slot 340 that opposes the first slot 338 relative to the central vertical axis 206. Accordingly, for brevity, only the first slot 338 will be discussed below. The first slot 338 extends from the first surface 332 to the second surface 334 through the coupler 328.

Housing 302 has a width 350. The width 350 is measured between edge 322 and edge 324 through the central vertical axis 206. Two apertures 348 are formed in wall 308 and received arms 349 on mechanism 304. The width between the two apertures 348 is less than the width 350.

In one particular embodiment, the locking mechanism housing 302 is formed from a uniform, monolithic member formed from a suitably rigid material so as to withstand deformation when the hose assembly 102 of the present disclosure moves through the locking mechanism housing 302. The locking mechanism housing 302 may be fabricated from a polymer material; however other rigid materials are entirely contemplated. Furthermore, the integral structure of the locking mechanism housing 302 may be fabricated from multiple elements having similar configurations as one having skill in the art would understand.

The slidable locking mechanism 304 includes a generally U-shaped frame 352 that defines a first minor surface 354, a second minor surface 356, a first major surface 358, a second major surface 360, a third surface 362, and a fourth surface 364. The first minor surface 354 faces the first end 202 of the locking sleeve 140. The second minor surface 356 is opposite the first minor surface 354 and faces the second end 204 of the locking sleeve 140. The first major surface 358 faces away from the central vertical axis 206. The second major surface 360 is opposite the first major surface 358 and faces toward the central vertical axis 206. The third surface 362 and the fourth surface 364 face away from the central vertical axis 206.

The first minor surface 354 and the second minor surface 356 extend from side-to-side and extend between the first major surface 358 and the second major surface 360. The first minor surface 354 and the second minor surface 356 extend generally perpendicular to the central vertical axis 206. The first major surface 358 and the second major surface 360 extend longitudinally relative to the central vertical axis 206 from the third surface 362 to the fourth surface 364. The first major surface 358 and the second major surface 360 extend generally parallel to the central vertical axis 206. The third surface 362 and the fourth surface 364 extend longitudinally relative to the central vertical axis 206. The third surface 362 and the fourth surface 364 extend generally parallel to the central vertical axis 206.

The slidable locking mechanism 304 further includes a first locking member 366, a structurally identical second locking member 368 (FIG. 4) that opposes the first locking member 366, a first spring mechanism 370, and a structurally identical second spring mechanism 372. Accordingly, for brevity, only the first locking member 366 and the first spring mechanism 370 will be discussed below. The first locking member 366 extends inward relative the central vertical axis 206 from a wall 359 through a bore in the slidable locking mechanism 304. The first locking member 366 extends inward toward another wall 361 on the other side of the frame 352 relative to the central vertical axis 206. The first spring mechanism 370 and the second spring mechanism 372 extend outward relative to the central vertical axis 206 from wall 359 to a circular surface 374 and 376 respectively. The first spring mechanism 370 includes a compression spring (not shown). When the spring is in a decompressed or extended state, the first spring mechanism 370 applies a force perpendicular to the central vertical axis 206 to the first locking member 366 thereby fully extending the first locking member 366 through the bore.

The slidable locking mechanism 304 further includes a third locking member 378 and a structurally identical fourth locking member 380 (FIG. 4) that opposes the third locking member 378. Accordingly, for brevity, only the third locking member 378 will be discussed below. The third locking member 378 extends inward relative to the central vertical axis 206 from the wall 359. The third locking member 378 includes a first major surface 382 that faces the first end 202 of the locking sleeve 140, a second major surface 384 opposite the first major surface 382 that faces the second end 204 of the locking sleeve 140, a first minor surface 386 that faces the second side 210, a first curved surface 388 that faces the central vertical axis 206, and a second curved surface 390 that faces toward the central vertical axis 206. The first major surface 382 extends inward relative to the central vertical axis from the wall 359 to the first curved surface 388 and the second curved surface 390. The first curved surface 388 concavely curves from the first minor surface 386 to the second curved surface 390. As will be discussed in further detail below, the curve of the first curved surface 388 corresponds to a curve of the hose 144. The second curved surface 390 concavely curves from the first curved surface 388 to the second major surface 360. The first curved surface 388 and the second curved surface 390 extend longitudinally relative to the central vertical axis from the first major surface 382 to the second major surface 384. The second major surface 384 extends outward relative to the central vertical axis 206 from the first curved surface 388 and the second curved surface 390 to the second major surface 360. The first minor surface 386 extends longitudinally relative to the central vertical axis 206 from the first major surface 382 to the second major surface 384. Furthermore, the first minor surface 386 abuts the third major surface 362.

The slidable locking mechanism 304 has a width 392 measured between the circular surface 374 and the circular surface 376 through the central vertical axis 206. The width 392 is greater than the width between aperture 348. Since the width 392 is greater than the width between apertures 348, when the slidable locking mechanism 304 is moved in a direction parallel to the central horizontal axis 212, the first spring mechanism 370 and the second spring mechanism 372 contact the surface 316.

In one particular embodiment, the slidable locking mechanism 304 is formed from a uniform, monolithic member formed from a suitably rigid material so as to withstand deformation when the hose assembly 102 of the present disclosure moves through the locking mechanism housing 302. The slidable locking mechanism 304 may be fabricated from a polymer material; however other rigid materials are entirely contemplated. Furthermore, the integral structure of the slidable locking mechanism 304 may be fabricated from multiple elements having similar configurations as one having skill in the art would understand.

FIG. 4 depicts the locking mechanism housing 302 coupled to the slidable locking mechanism 304, wherein the slidable locking mechanism 304 is in a first position or an unlocked position. When the slidable locking mechanism 304 is coupled to the locking mechanism housing 302 and in the first position (FIG. 4), the two grooves 327 slidably receive wall 359 and wall 361 allowing the frame 352 to slide horizontally.

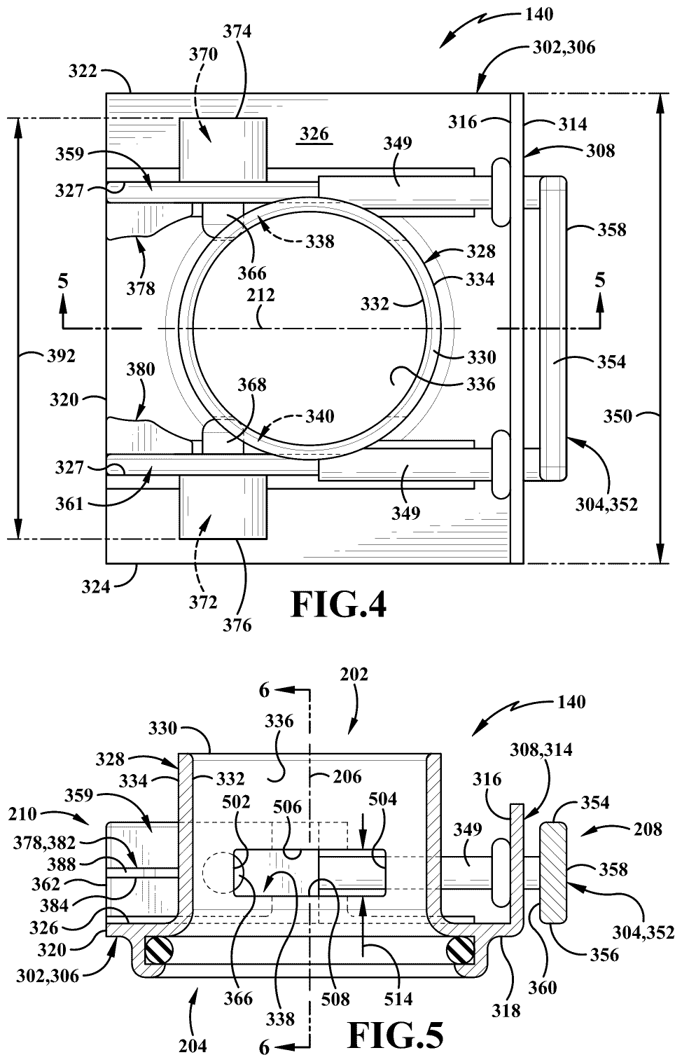

FIG. 5 further depicts the locking mechanism housing 302 coupled to the slidable locking mechanism 304, wherein the slidable locking mechanism 304 is in the first position. As shown in FIG. 5, the second slot 340 is generally horizontally rectangular. The slot 338 includes a first side 502, a second side 504 that opposes the first side 502, and a first end 506 and a second end 508 that opposes the first end 506. The first side 502 and the second side 504 extend generally parallel to the central vertical axis 206. The first end 506 and the second end 508 extend generally perpendicular to the central vertical axis 206. The slot 338 has a height 514 measured between the first end 506 and the second end 508 parallel to the central vertical axis 206.

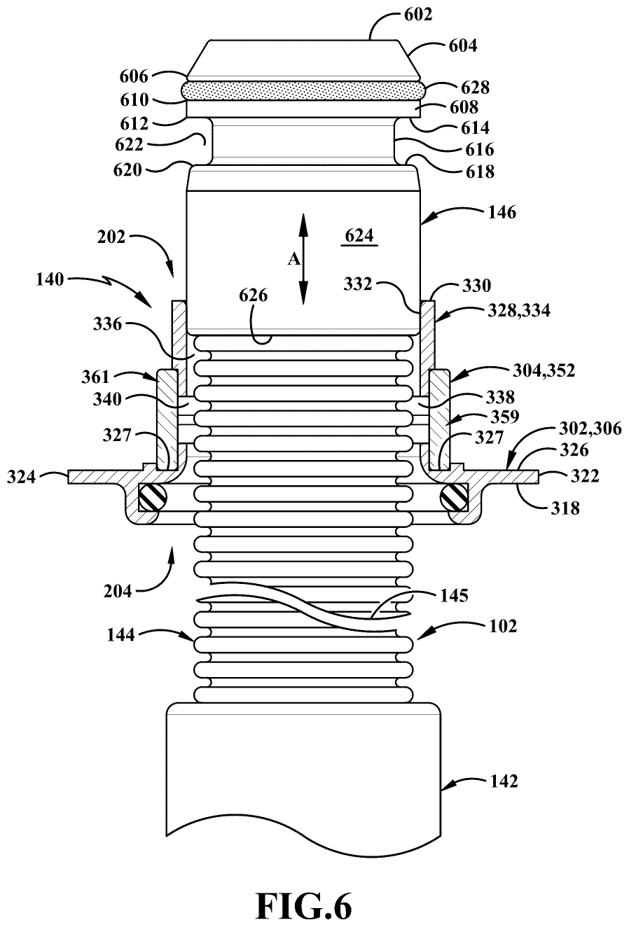

When the slidable locking mechanism 304 is in the first position, the first locking member 366 contacts the second surface 334 of the coupler 328 and contacts the first side 502 second slot 340. This contact compresses the first locking member 366 into the bore of the frame 352 and into the first spring mechanism 370. As such, the first locking member 366 does not extend through the slot 338. As further shown in FIG.5, when the slidable locking mechanism 304 is in the first position, the third locking member 378 does not extend through the slot 338. Thus, when the slidable locking mechanism 304 is in the first position, neither the first locking member 366 nor the third locking member 378 couple to the hose assembly 102. As such, the hose assembly 102 may move in either direction of arrow A (FIG. 6). For instance, the hose assembly 102 may fully extend through the locking sleeve 140 and be removed from the valve box 100 for use at another inlet valve or may fully retract into the conduit 128 for storage.

As depicted in FIG. 6, the hose cuff 146 includes a first annular surface 602. The first annular surface 602 defines a first opening of the hose cuff 146. An annular pitched or tapered surface 604 extends from the first annular surface to a first outer edge 606. A first outer surface 608 extends longitudinally from a second outer edge 610 to a third outer edge 612. A second annular surface 614 extends radially inward from the third outer edge 610 to a second outer surface 616. The second outer surface 616 extends longitudinally from the second annular surface 614 to a third annular surface 618. The third annular surface 618 extends from the second outer surface 616 to a fourth outer edge 620. A fourth outer surface 624 extends from the fourth outer edge 620 to fourth annular surface 626. The fourth annular surface 626 defines a second opening of the hose cuff 146. A seal 628 nests between the first outer edge 606 and the second outer edge 610. The seal 628 is the radial outermost portion of the hose cuff 146. The seal 628 is a generally annular or ring like member defining an interior aperture. In one particular embodiment, first seal 628 is generally shaped like a torus such that it has a convexly curved continuous outer surface. The seal 628 may generally be referred to as an O-ring having elastomeric properties.

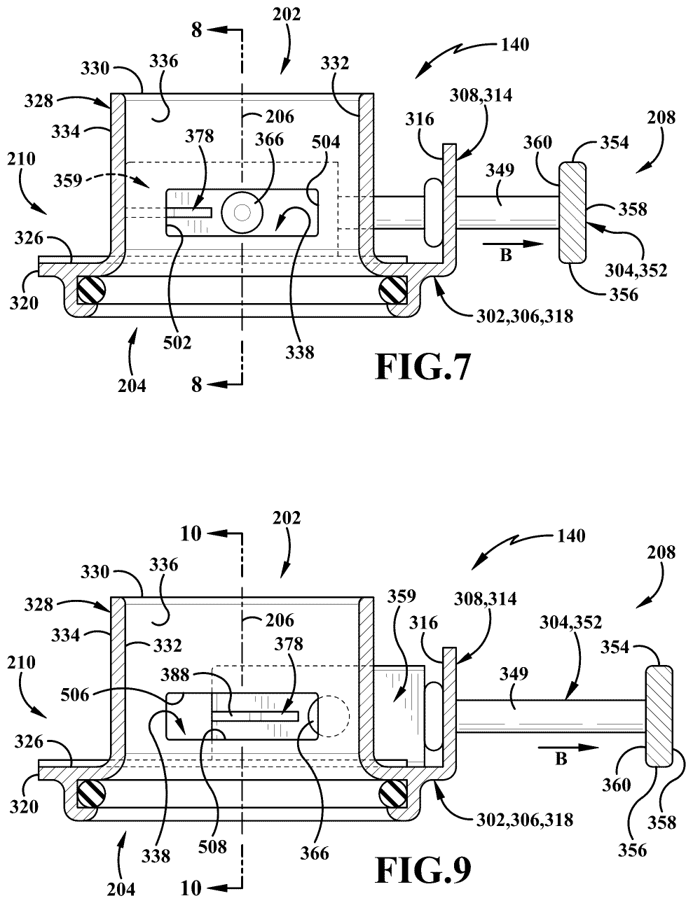

FIG. 7 depicts the locking mechanism housing 302 coupled to the slidable locking mechanism 304, wherein the slidable locking mechanism 304 has been moved in the direction of arrow B to a second position or a fully extended hose locking position. When the slidable locking mechanism 304 is in the second position, the first locking member 366 does not contact the first side 502 of the slot 338. As such, the spring of the first spring mechanism 370 is decompressed thereby fully extending the first locking member 366 through the bore of the frame 352 and the second slot 340 into the bore 336 of the coupler 328. Furthermore, when the slidable locking mechanism 304 is in the second position, the first curved surface 388 of the third locking member 378 does not extend through the slot 338.

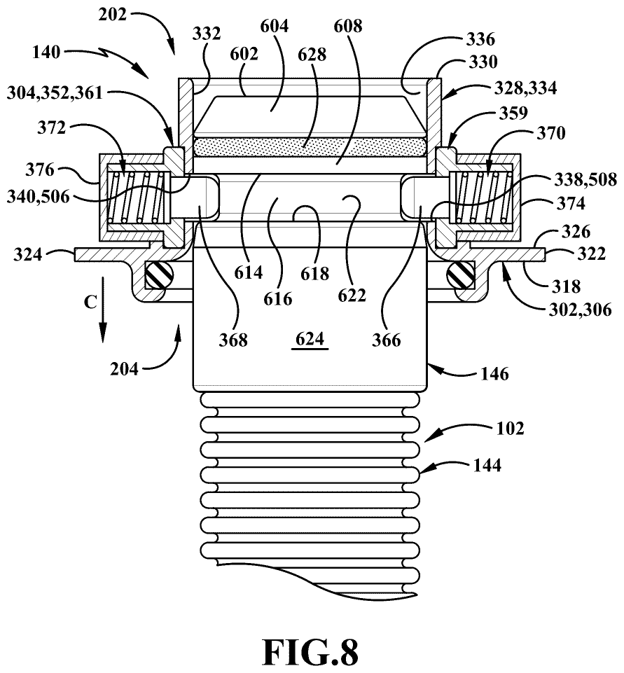

FIG. 8 depicts the locking sleeve 140 coupled to the hose cuff 146. When the hose assembly 102 is moved in the direction of arrow C first locking member 366 contacts either the hose 144 or the fourth outer surface 624 of the hose cuff 146 until it enters the channel 622 of the hose cuff. When contacting the hose 144 or the fourth outer surface 624, the first locking member 366 is compressed into the bore of the frame 352 and into the first spring mechanism 370. As such, the first locking member 366 does is not fully extend through the slot 338. When the hose assembly 102 is moved to the position shown in FIG. 8, the spring decompresses and the first locking member 366 fully extends through the slot 338 and into the channel 622 of the hose cuff 146. When in the channel 622, the first locking member 366 and the second locking member 368 nest between second annular surface 614 and the third annular surface 618 thereby locking the hose assembly 102 into a fully extended position. When in the fully extended position, the seal 628 forms a generally hermetic seal with the coupler 328 of the locking sleeve 140.

FIG. 9 depicts the locking mechanism housing 302 coupled to the slidable locking mechanism 304, wherein the slidable locking mechanism 304 has been moved in the direction of arrow B to a third position or a partially extended hose locking position. When the slidable locking mechanism 304 is in the third position, the first locking member 366 contacts the second surface 334 of the coupler 328 and contacts the second side 504 of the second slot 340. This contact compresses the first locking member 366 into the bore of the frame 352 and into the first spring mechanism 370. As such, the first locking member 366 does not extend through the second slot 340. As further shown in FIG. 9, when the slidable locking mechanism 304 is in the third position all of the third locking member 378 extends through the slot 338.

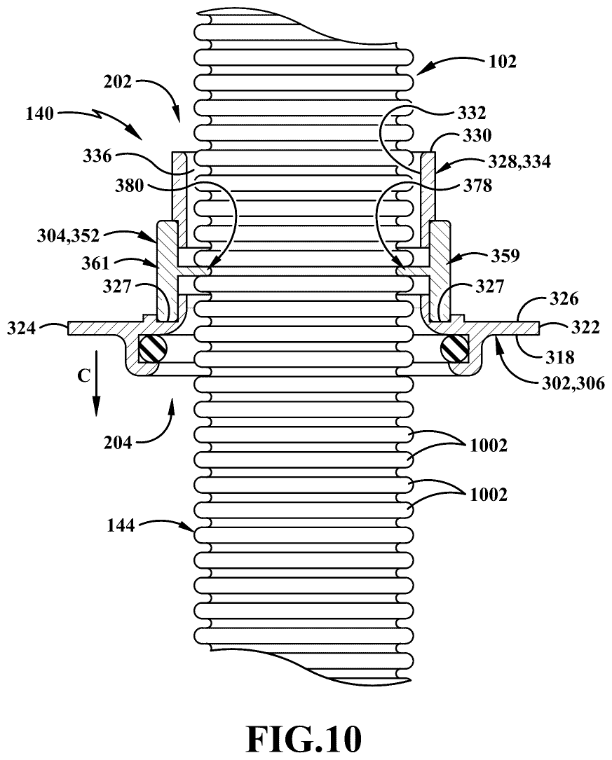

FIG. 10 depicts the locking sleeve 140 coupled to the hose 144 of the hose assembly 102. A user may extend the hose 144 in the direction of arrow D to a desired position outside of the valve box 100. The desired position may be less than a fully extended position of the hose 144. When in the desired position, the user moves the slidable locking mechanism 304 to the third position (see FIG. 9). The hose 144 includes a plurality of ribs 1002 extending from an outer surface 1004 of the hose 144. When in the third position, the third locking member 378 and the fourth locking member 380 nest between two ribs 1002 of the hose 144. Furthermore, a curvature of the first curved surface 388 is complementary to a curvature of the outer surface 1004 of the hose 144. Since the third locking member 378 and the fourth locking member 380 nest between the two ribs 1002 and since the third locking member 378 and the outer surface 1004 of the hose 144 have similar curvatures, the third locking member 378 and the fourth locking member 380 couple to the hose 144 thereby locking the hose 144 to the locking sleeve 140 at the desired position. It is envisioned that locking sleeve 140 may lock the hose 144 at any position when the slidable locking mechanism 304 is in the third position so long as the third locking member 378 nests between two ribs 1002.

The first position of the slidable locking mechanism 304 may correspond to an unlocked position. In this position, the hose assembly 102 may be completely removed from the valve box 100. The second position of the slidable locking mechanism 304 may correspond to a fully extended position of the hose assembly 102. In this position, a user may extend the hose assembly 102 from the valve box 100 until the locking sleeve 140 couples to the hose cuff 146 of the hose assembly 102. The third position may correspond to a partially extended position of the hose assembly 102. In this position, after a user extends the hose assembly 102 to a selected or desired length from the valve box 100 that is less than the fully extended position, the locking sleeve 140 couples to the hose 144 of the hose assembly 102.

When the hose assembly 102 is stored within the valve box 100. The locking sleeve 140 may be in the first position which allows a user to partially or wholly remove the hose assembly 102 from the valve box 100. If a user desires to wholly remove the hose assembly from the valve box 100 in order to use the hose assembly with a different valve box, the user keeps the slidable locking mechanism 304 first position as the locking sleeve 140 does not couple to the hose assembly 102 when in the first position. The user may then completely remove the hose assembly 102 for use with a different valve box.

If a user desires to completely extend the hose assembly 102 so that the hose assembly may be used with the valve box 100, the user may move the slidable locking mechanism 304 to the second position. The user may move the slidable locking mechanism 304 to the second position from either the first position or the third position. In one example, a user may desire to extend all of the hose assembly 102 from the valve box 100 when the hose assembly 102 is stored in the valve box 100. In this position, the locking sleeve 140 may be in the first position. Hence, the user may move the slidable locking mechanism 304 from the first position to the second position and extend the hose assembly 102 from the valve box 100 until the locking sleeve 140 couples to the hose cuff 146. In another example, a user may have the partially extended the hose assembly 102 from the valve box 100 and then may desire to fully extend the hose assembly 102 for use with the valve box 100. In this example, the user may move the slidable locking mechanism 304 from the third position to the second position when a desired length of the hose assembly 102 has been removed from the valve box 100. In this position, the locking sleeve 140 couples to the hose 144.

If a user desires to partially extend the hose assembly 102 so that the hose assembly may be used with the valve box 100, the user may move the slidable locking mechanism 304 to the third position. In one example, a user may desire to partially extend the hose assembly 102 from the valve box 100 when the hose assembly 102 is stored in the valve box 100. In this position, the locking sleeve 140 may be in the first position. Hence, the user may move the slidable locking mechanism 304 from the first position to the third position and extend a desired amount of the hose assembly 102 from the valve box 100. After extending a desired amount, the user may move the slidable locking mechanism 304 from the first position to the third position by sliding the locking mechanism beyond the second position. In this third position, the locking sleeve 140 couples to the hose 144. In the previous example, a user may have fully extended the hose assembly 102 for use with the valve box 100 and but now desires to use only a partial amount of the hose assembly 102. In this example, the user moves the slidable locking mechanism 304 from the second position to the first position then retracts a desired amount of the hose assembly 102 into the valve box 100. When a desired amount of the hose assembly 102 remains outside of the valve box 100, the user moves the slidable locking mechanism from the first position to the third position. In this position, the locking sleeve 140 couples to the hose 144.

Based on the foregoing description, it now understood that the slidable locking mechanism is able to selectively lock the hose 144 at various lengths relative to the valve box 100. As such, the slidable locking mechanism enables a great range of variety for the user by allowing the user to selectively choose a desired length of vacuum hose to extend from the valve box and that selected length of hose to be locked at the selected length.

A user may desire to fully retract the hose assembly 102 into the valve box 100 for storage when the slidable locking mechanism 304 is in either the first, second or third position. If the slidable locking mechanism 304 is in the first position, the user does not move the slidable locking mechanism 304 and retracts the slidable locking mechanism 304 into the valve box 100. If the slidable locking mechanism 304 is in either the second or third position, the user moves the slidable locking mechanism 304 into the first position and retracts the hose assembly into the valve box 100.

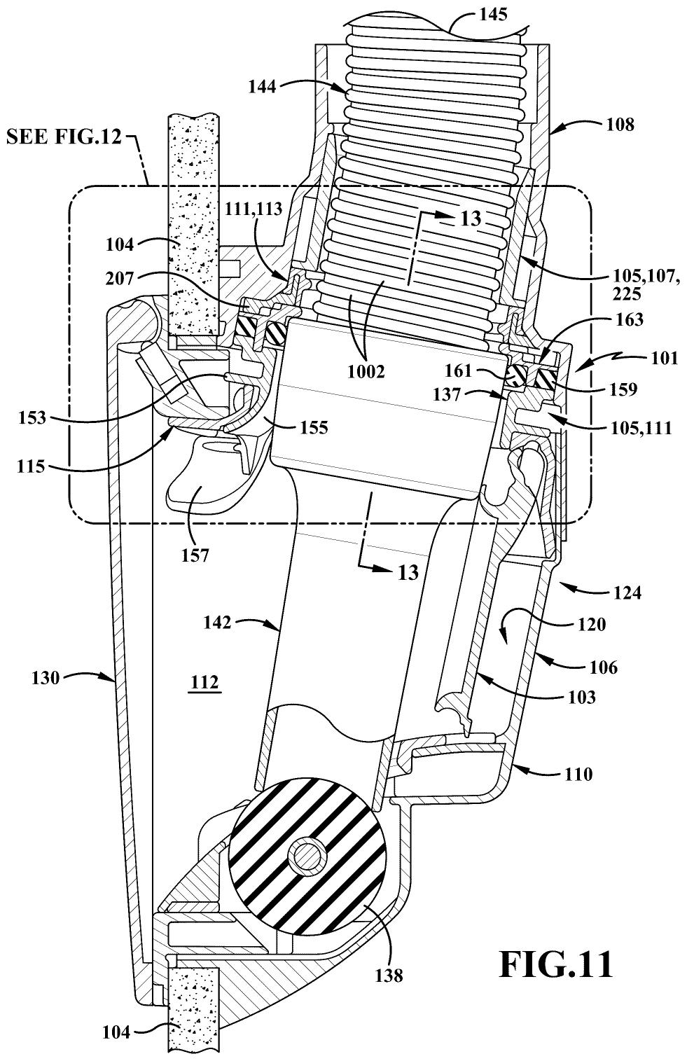

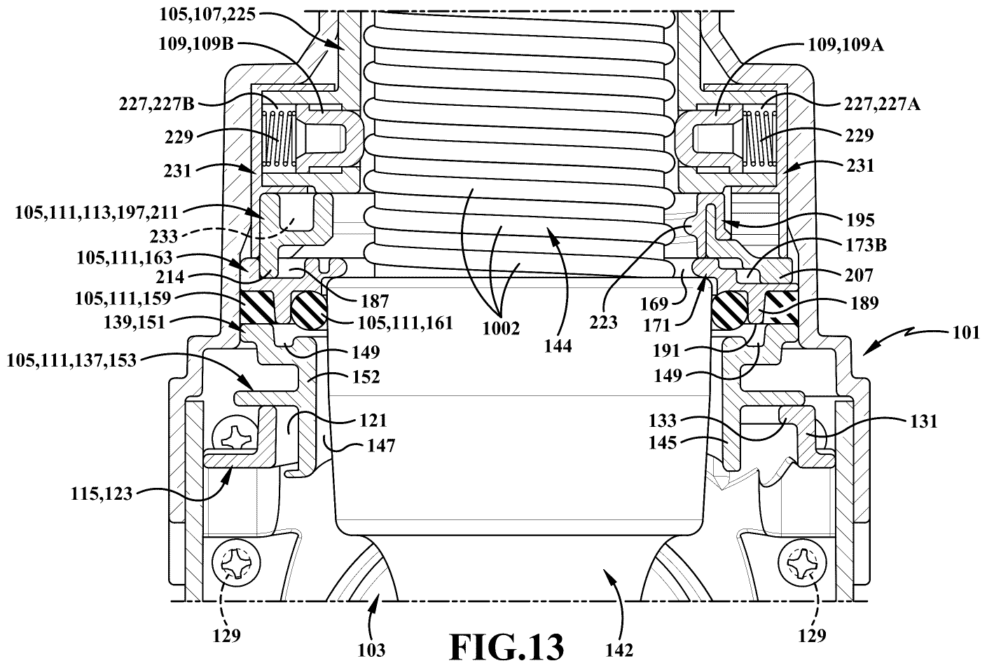

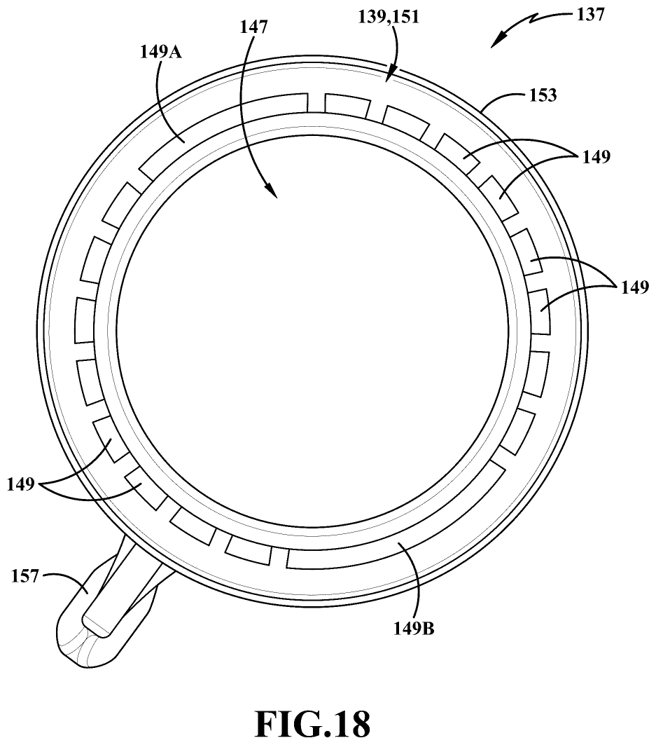

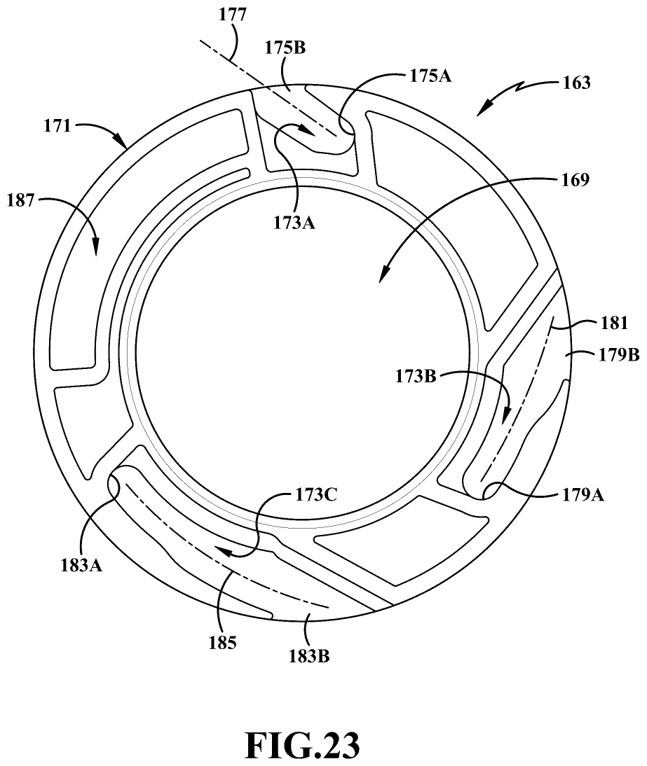

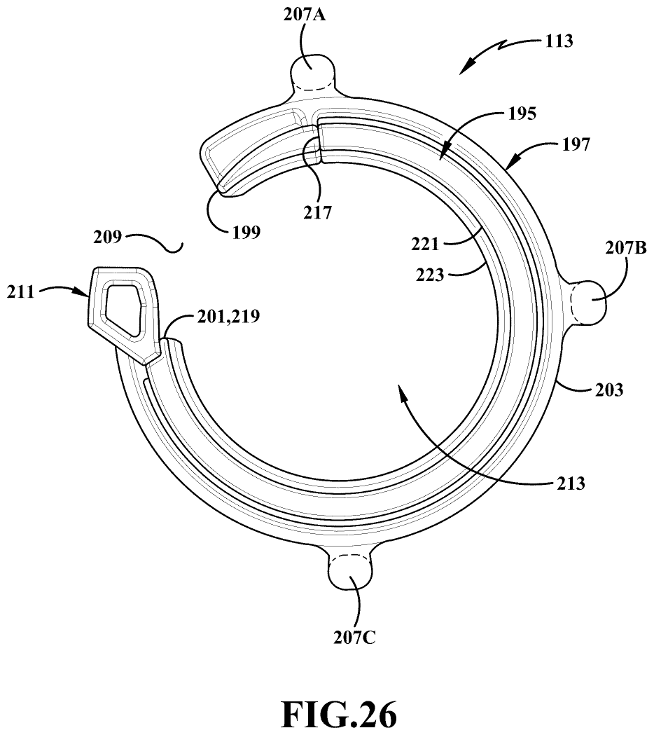

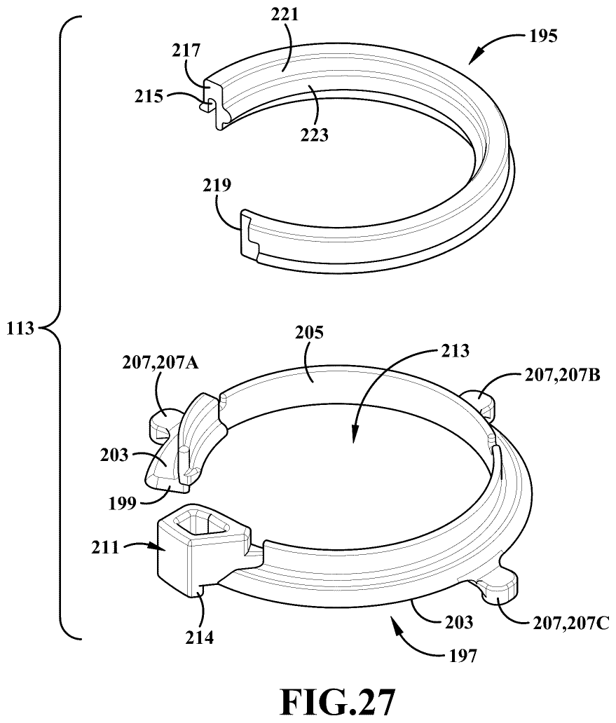

FIG. 11 depicts another embodiment of valve box assembly or valve box 101. Valve box 101 may include many similar components as valve box 100, despite being shaped or configured slightly different. For brevity, components having similar reference numerals are not repeated but are understood to function in a similar manner to that which has already been described. Valve box 101 may also include a closeable flap 103 as taught in Applicant's U.S. Pat. Nos. 11,534,044 and 11,903,553, and U.S. patent application Ser. No. 17/865,023, the entirety of each of which is incorporated herein by reference in their entirety. Rather than using a sliding locking action that was shown in FIGS. 1-10, the valve box assembly 101 depicted in FIGS. 11-36 utilizes a locking assembly that utilizes a rotational cam action.

FIG. 11-FIG. 13 depict the valve box assembly 101 of the central vacuum system having a locking assembly 105 to selectively secure the vacuum hose 144 at various lengths relative to the valve box assembly 101 of the central vacuum system. The locking assembly 105 includes a first locking subassembly 107 comprising at least one moveable pin 109. The locking assembly 105 also includes a different second locking subassembly 111 comprising a variable diameter split ring clamp 113. When the first locking subassembly 107 and the different second locking subassembly 111 are both in their respective unlocked positions (collectively an unlocked position of locking assembly 105), the vacuum hose 144 freely extends and retracts relative to the valve box assembly 101. When the first locking subassembly 107 is in a first locked position, the at least one moveable pin 109 couples to an end of the vacuum hose 144 and locks the vacuum hose relative to the valve box assembly 101. When the different second locking subassembly 111 is in a second locked position, the variable diameter split ring clamp 113 couples to a hose rib 1002 positioned along an intermediate length of the vacuum hose 144 and locks the vacuum hose 144 relative to the valve box assembly. Prior to moving the locking assembly 105 to the second locked position, the vacuum hose 144 is moved into the valve box assembly 101 to alter a length of the vacuum hose 144 that extends from the valve box assembly 101. The length of the vacuum hose 144 that extends from the valve box assembly 101 assembly in the second locked position is shorter than the length of the vacuum hose 144 that extends from the valve box in the first locked position.

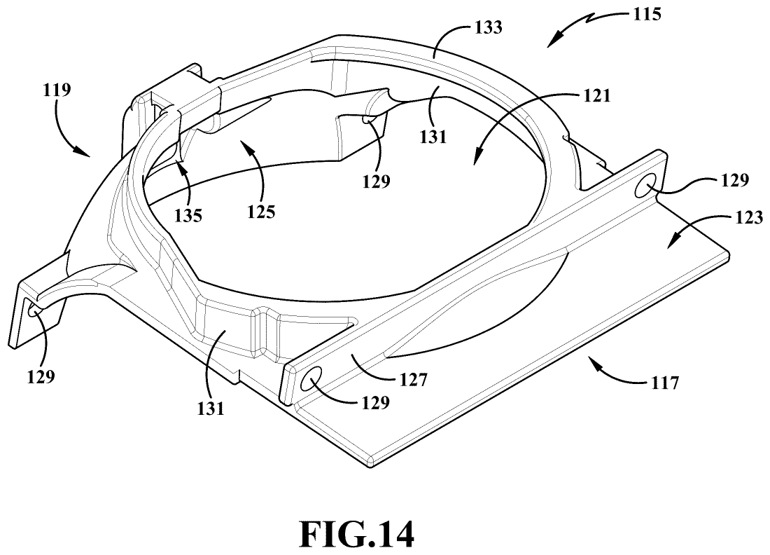

FIG. 14-FIG. 31 depict various components, aspects, or subassemblies of the locking assembly 105 that is utilized within the valve box assembly 101 in the manner described above.

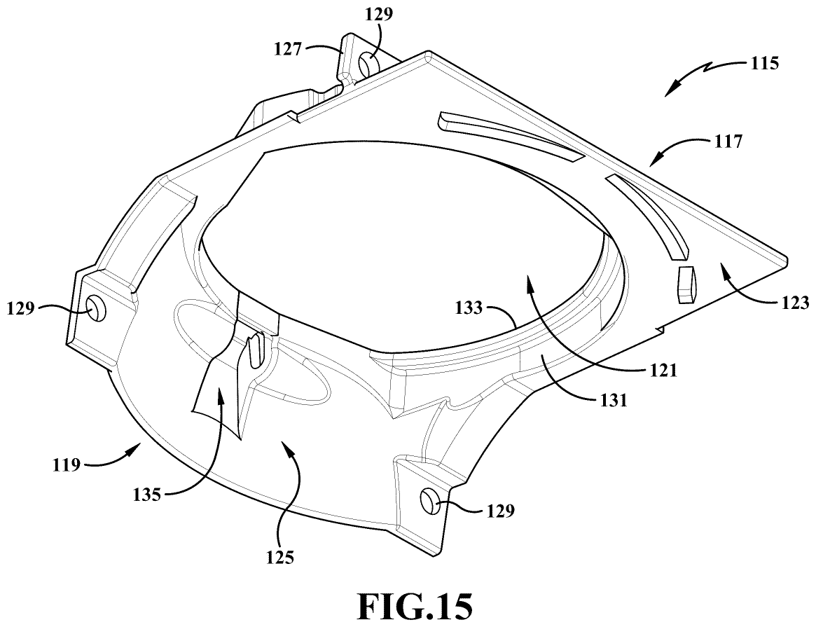

FIG. 14 and FIG. 15 depict a retaining member or retainer 115 that is installed in the valve box assembly 101 in a manner that retains or otherwise secures other components of the locking assembly 105. Retainer 115 includes a forward end 117 and a rear end 119. Retainer 115 defines a central aperture 121 through which the hose 144 may extend. Retainer 115 includes a generally flat and planar forward portion 123 and a downwardly extending rear portion 125. A mounting bar 127 may extend upwardly from the top surface of the flat forward portion 123, forward from the aperture 121, and define screw holes 129 therethrough. Screw holes 129 are configured to receive screws to secure the retainer 115 to the valve box assembly 101. Similarly, the downwardly extending rear portion 125 may define additional screw holes 129 to assist with mounting the retainer 115 to the valve box assembly 101. In the shown embodiment, the retainer 115 is integrally molded as a unibody monolithic member. The central aperture 121 of the retainer 115 is defined by a generally upwardly extending cylindrical or annular wall 131 that has a top edge 133 that extends inwardly towards the center of the aperture 121. Top edge 133 extends inwardly and is configured to support other components of the locking assembly 105 there above or thereon. The inner edge defines the smallest diameter of aperture 121. For example, as will be described in greater detail below, the actuator that operates the rotational locking action of the second locking subassembly 111 rests atop the edge 133 that is generally horizontal. A recessed region 135 may be formed in the frontal surface of the downwardly extending rear portion 125 and receives the closure flap 103 therein. As shown in FIG. 15, the lower surface of the flat forward portion 123 may have downwardly extending sloped surface that allow a portion of the actuator, namely the handle or lever, to move therealong during the rotational action of the actuator. One of the sloped surfaces may be interrupted with a detent to effective secure the lever of the actuator in that detent, which is associated with the second locking assembly being in the second locked position.

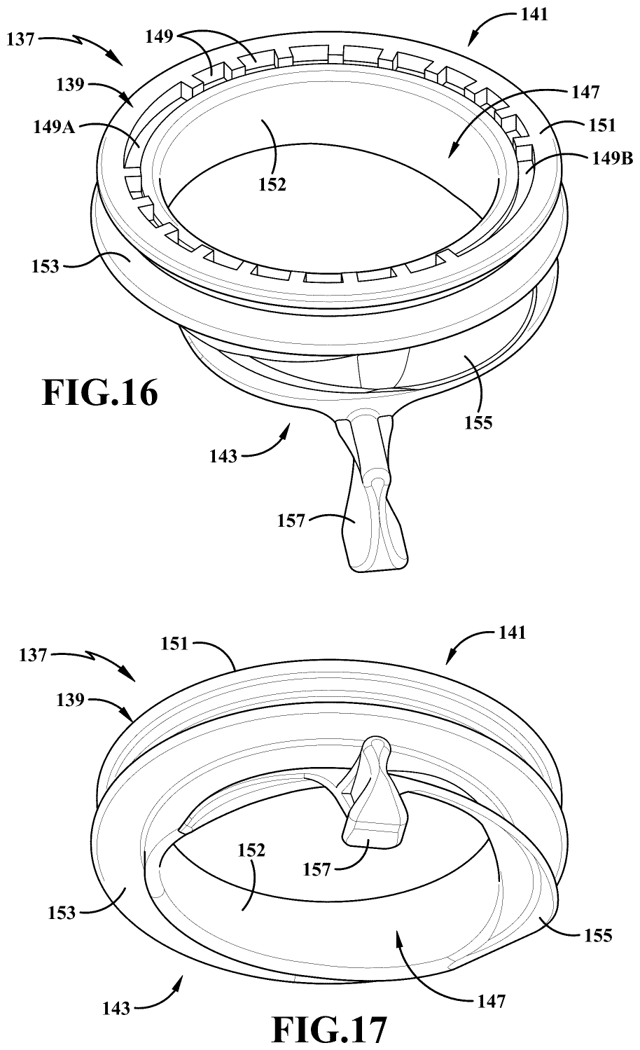

FIG. 16-FIG. 18 depict another component of the locking assembly 105, namely an actuating member or actuator 137. The actuator 137 is part of the second locking subassembly 111 and cooperates with other components of second locking subassembly 111 to impart the rotational action thereof to move the second locking assembly between the unlocked and second locked position. Actuator 137 is a generally annular member having a body 139 having an upper end 141 and a lower end 143. The body 139 defines an inner cylindrical side wall 152 that defines a central opening 147. The central opening 147 is configured to receive the hose 144 therethrough when the actuator 137 is installed in the valve box assembly 101 as part of the second locking subassembly 111. A plurality of recesses 149 are formed in the upper surface of the upper end 141 of the body 139. At least two diametrically opposed recesses 149A, 149B are greater in arcuate length than the remainder of the recesses 149. However, it is understood that all recesses could have the same arcuate length if necessary for the application specific needs of the second locking subassembly 111. As will be described in greater detail below, the longer recesses 149A, 149B receive a portion of the cam track ring (discussed below) when the locking assembly 105 is assembled within the valve box assembly 101. A ledge 151 surrounds the perimeter of the recesses 149, 149A, and 149B. The body 139 of the actuator 137 extends downward below the ledge 151 such that the upper ledge 151 overhangs the outer surface of the body having a greater diameter there above. The body extends downward to an intermediate ledge 153 that is generally annular in configuration. The body 139 continues to extend downward from the intermediate ledge 153 defining a lower portion of the actuator 137. The body continues to extend downward such that the inner wall 152, which defines central opening 147, is continuous from the inner diameter of the ledge 153. The body 139 continues downward and defines a downwardly extending and outwardly projecting lip 155. The lip 155 projects outwardly radial from the body 139 but does not complete a full revolution around the body. In one particular embodiment, the lip 155 extends downwardly and projects outwardly approximately 180 degrees around the central aperture 147. The lip 155 includes a concave radial outer surface and a convex radial inner surface. The concave outer surface of the lower lip 155 is configured to contact a corresponding convex surface on the retainer 115 that is located at the transition between the upper annular wall 131 and the remainder of the planer flat forward portion 123. On the lip 155, there is a handle or lever 157 that extends radially outward from the lip 155. The lever 157 assists in the rotational action of the actuator 137 to move the second locking subassembly 111 between its unlocked position and the second locked position.

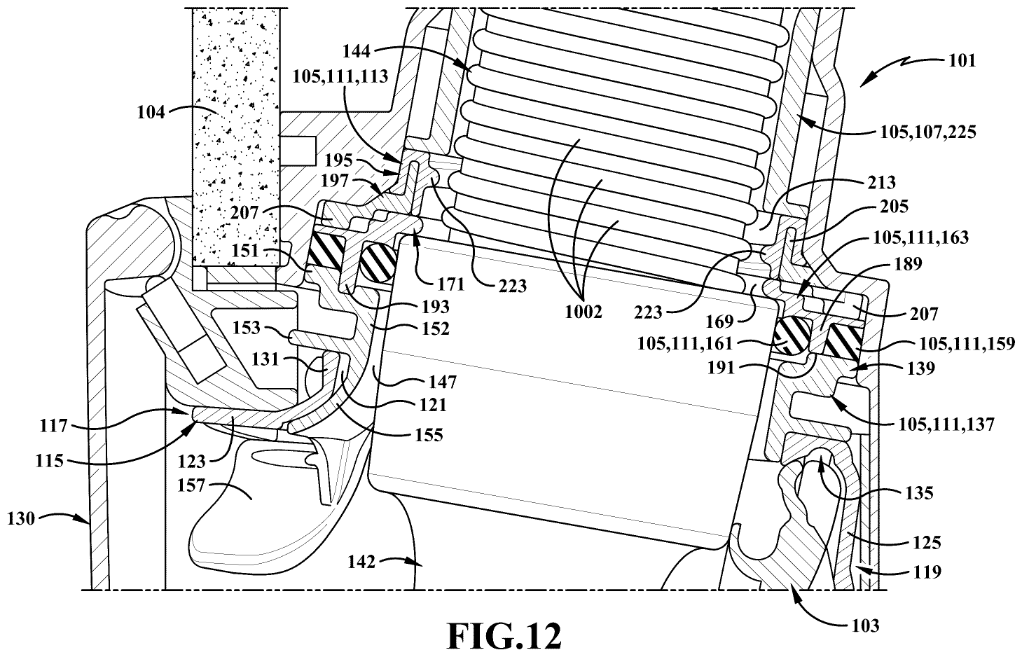

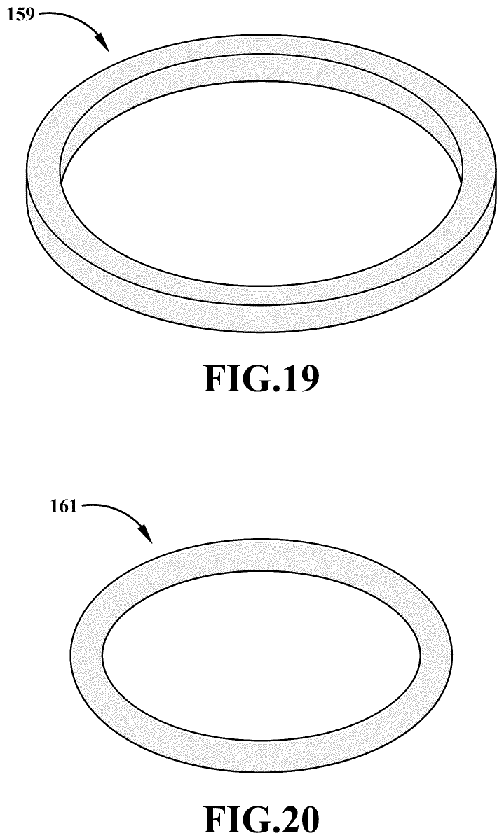

FIG. 19 depicts a foam ring 159 that is part of the second locking subassembly 111 in the locking assembly 105. The foam ring seal 159 is generally rectangular in cross section. When installed as part of the second locking subassembly 111, the foam ring seal 159 is positioned atop the actuator 137 and primarily covers the upper ledge 151 at the perimeter thereof. The foam ring seal 159 sits below the cam track ring (see FIG. 12) and is retained by a downwardly extending wall, as discussed below.

FIG. 20 depicts an O-ring seal 161 that is also part of the second locking subassembly 111. The O-ring seal 161 has a narrower diameter than foam ring seal 159. The O-ring seal 161 is also installed atop the actuator 137 and positioned below the cam track ring on an opposite side of the downwardly extending wall from the foam ring seal 159 (see FIG. 12).

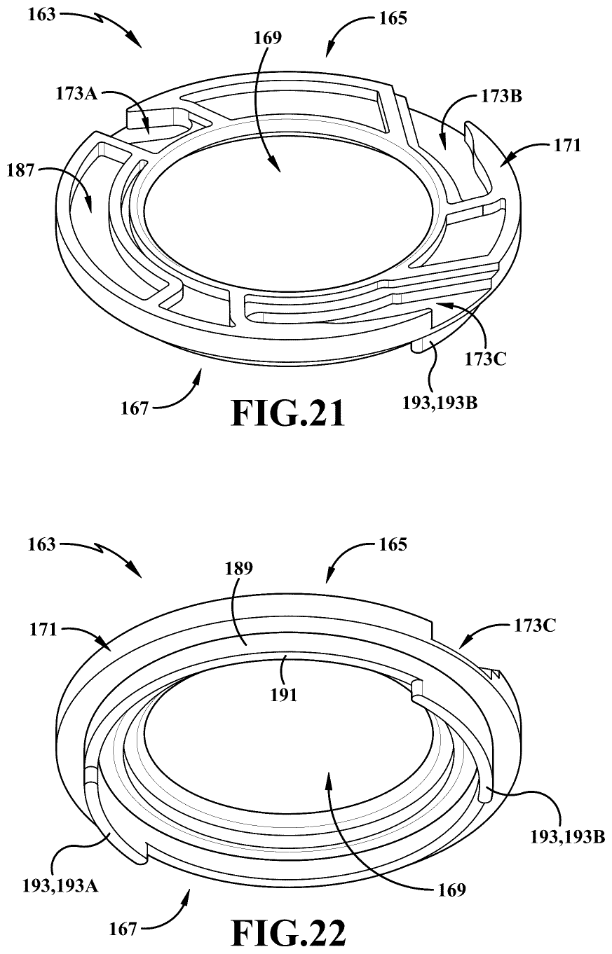

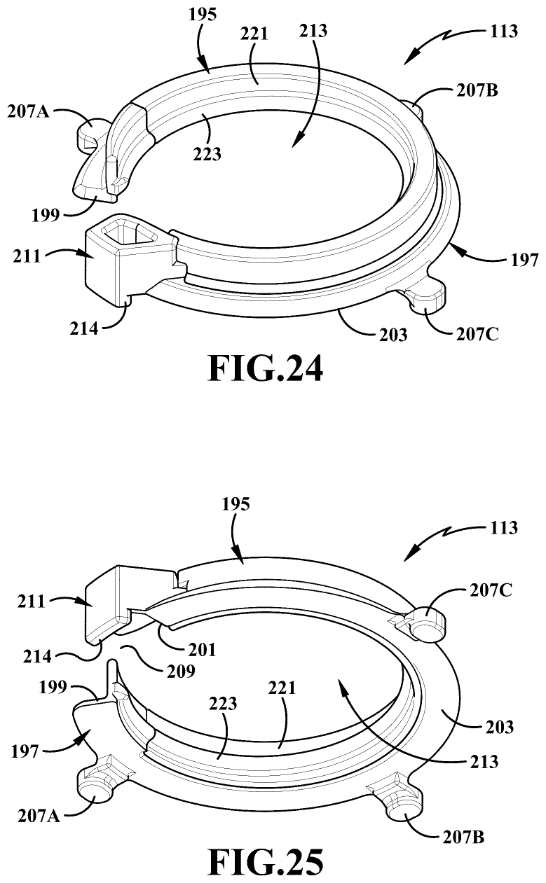

FIG. 21-FIG. 23 depict a cam track ring 163 that is part of the second locking subassembly 111 of the locking assembly 105. Cam track ring is a generally annular member that may be integrally molded and formed as a monolithic unibody having the structural features detailed herein. Cam track ring 163 includes a top 165 and a bottom 167. As an annularly shaped member, the cam track ring defines a central aperture 169. The hose 144 will extend through the central aperture 169 of the cam track ring 163 when the cam track ring is installed as part of the second locking subassembly 111. More particularly, the central aperture 169 is defined by an annular body 171. The annular body 171 has a plurality of slots that function as cams defined in the top surface thereof for a follower component (e.g., protrusions 207, discussed below in FIG. 24-25). In the shown configuration there are three slots formed in the top surface of the annular body. Namely, a first slot 173A, a second slot 173B, and a third slot 173C. Slots 173A-173C are configured to receive protrusions or bosses on the split ring C-clamp 113 such that rotation of the cam track ring 163 causes those protrusions or bosses to follow the cam action and slide within the slots 173A-173C to vary the diameter of the split ring C-clamp 113. However, it is to be understood that a different number of slots could be utilized.

First slot 173A includes a closed inner end 175A and an open outer end 175B. The closed inner end 175A is radially closer to the center of the aperture 169 than the open outer end 175B. An axis 177 extends from the inner end 175A to the outer end 175B. Axis 177 is eccentric and offset from the center of the central aperture 169. Although the outer end 175B is shown as being radially open, it is possible for the outer end 175B to be enclosed such that the first slot 173A is bound between the closed inner end 175A and the outer end 175B. One of the protrusions or bosses on the split ring C-clamp 113 moves, typically in a sliding movement along axis 177, in response to a rotational cam action of the cam track ring 163.

The second slot 173B extends between a closed inner end 179A and an open outer end 179B. The closed inner end 179A of the second slot 173B is radially closer to the center of the central aperture 169 than the outer open end 179B. The second slot 173B enables a protrusion or boss to slide along axis 181 that extends from the closed inner end 179A to the open outer end 179B. The length of the second slot 173B is longer than the length of the first slot 173A. As such, it can be seen that the axis 181 is eccentric to the center of the central aperture 169 at a different angle relative thereto than the axis 177. Similarly, although the outer end 179B is depicted as an open outer end, it is possible for the outer end 179B to be closed such that the second slot 173B is bounded between the closed inner end 179A and a closed outer end.

The third slot 173C extends from a closed inner end 183A to an open outer end 183B. The closed inner end 183A is radially closer to the center of the central aperture 169 than the open outer end 183B. An axis 185 extends through the third slot 173C from the closed inner end 183A to the open outer end 183B. One of the protrusions on the split ring C clamp 113 will slide along the axis 185 within the third slot 173C in response to the rotational action of the cam track ring 163 in order to vary the diameter of the split ring clamp 113. Similarly, although the open out end 183B is shown as radially open, it is entirely possible to have the outer end be closed such that the third slot 173C is bounded and extends from the closed inner end 183A to a closed outer end. The axis 185 is eccentric to the center of the central aperture 169. The length of the third slot 173C is greater than the length of the second slot 173B. As such, the axis 185 is oriented at a different angle than the first axis 177 and the second axis 181 relative to the center of the central aperture 169.

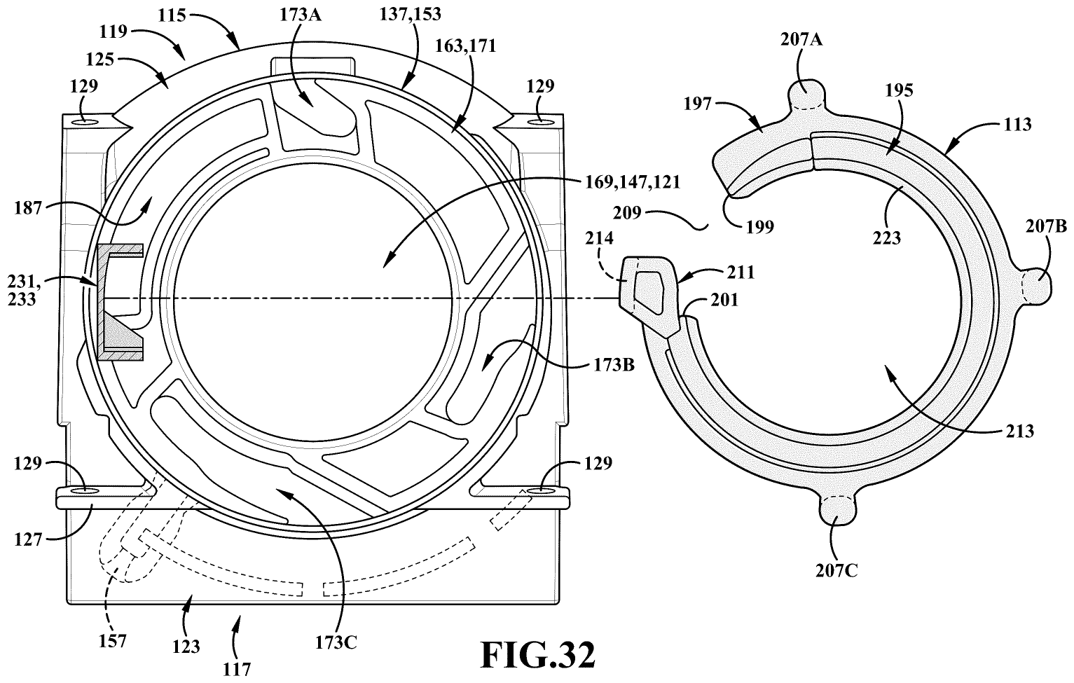

Also formed within the top of the cam track ring 163 is a retaining region 187 above which a retaining bracket (see FIG. 32) will be mounted. The retaining region 187 is bounded by walls that enclose at least a partially circumferential portion of the retaining region 187. The retaining region 187 is configured to receive a lower depending portion 214 (see FIG. 24) of a base protrusion on the split ring C-clamp 113. The retaining region 187 bounds or limits the movement of the base member 211 (See FIG. 24) between a maximum and minimum radial displacement. However, the base member remains in a releasably fixed position such that it remains within the bracket above or within retaining region 187 and substantially does not move, relative to perimeter or circumferential movement, as the cam track ring 163 is rotated and the other protrusions on the split ring C-clamp 113 slide within the respective slots 173A-173C.

The cam track ring 163 includes a cylindrical side wall 189 that extends downwardly from the lower surface of the annular body 171. The cylindrical side wall 189 terminates at a lower end 191. Cylindrical side wall 189 has two diametrically opposed downward projections 193 that extend farther downward than the end 191 of wall 189. Namely, a first downward projection 193A and a second downward projection 193B. Each of the projections 193 is generally arcuate having the same radius of curvature as the cylindrically side wall 189. The projections 193 extend in an arcuate manner between first and second ends and have an arc length that corresponds to approximately 60 degrees. However, other arc lengths of the projections 193 are entirely possible depending on the application specific needs of the locking assembly 105. The projections 193 correspond to and complement the longer recesses 149A, 149B on the actuator. Stated otherwise, the cam track ring 163 is configured to sit atop the actuator 137 such that the downward projections 193 fit within the longer recesses 149A, 149B to releasably couple the cam track ring 163 to the actuator 137 in a selectively fixed orientation. The releasable connection of the cam track ring 163 to the actuator 137 allows them to rotate in unison when they are releasably, yet fixedly, connected. More particularly, the first and second ends of the downward projections 193 contact the respective ends of the elongated recesses 149A, 149B in the actuator 137. The longer recesses 149A, 149B and the projections 193A, 193B also function as a poka-yoke configuration to ensure that the installation of the cam track ring 163 atop the actuator 137 is installed in the correct manner that aligns the cam track ring 163 above the actuator 137 in a proper orientation and it cannot be installed incorrectly. Although this poka-yoke confirmation is envisioned, other poka-yoke configurations are entirely possible that releasably couple the cam track ring to the actuator. The apertures 169 and 147 of the cam track ring 163 and actuator 137, respectively, are aligned when the cam track ring 163 is releasably connected above the actuator 137.

FIG. 24-FIG. 27 depict the split ring C-clamp 113. Clamp 113 is composed of a C-shaped seal 195 and a C-shaped clamp body 197. The seal 195 is configured to mate with the clamp body 197. The clamp body 197 is generally C-shaped and formed from a flexible or semi-flexible material allowing the clamp body 197 to vary its diameter in response to the rotational action of the actuator and/or cam track ring 163. The clamp body 197 includes a first end 199 and a second end 201. The clamp body 197 extends in an arcuate manner between the first and second ends 199, 201. The clamp body 197 includes a lower horizontal wall 203 that has a radial outer edge and a radial inner edge. The clamp body 197 includes a vertical wall that extends upwardly from the radial inner edge of the lower horizontal wall 203. The vertical wall 205 terminates at an upper end that is positioned above the lower horizontal wall 203. The vertical wall 205 is configured to be inserted in a receiving channel 215 defined by the clamp seal 195 as will be described in greater detail herein.

The clamp body 197 includes a plurality of protrusions or bosses that extend radially outward from the radial outer edge of the lower horizontal wall 203. For example, there may be three protrusions or bosses 207. A first protrusion 207A is located closest to the first end 199. A second protrusion 207B is located approximately diametrically opposite an opening 209 defined between the first end 199 and second end 201 when the split ring C-clamp is in its unlocked and unstressed resting position. It is to be understood that the opening 209 is present when the second locking subassembly 111 is in its unlocked position and the split ring C-clamp 113 is in an unstressed resting position. A third protrusion 207C is located between the second protrusion and the second end 201 and extends radially outward from the lower horizontal wall 203. Each of the protrusions 207 may include a downwardly extending outer end or lower tip. The shape of the protrusions enables them to fit into the slots 173 formed in the cam track ring when the split ring C-clamp 113 is installed atop the cam track ring 163. These protrusions function as the followers for the cam action imparted by the rotation of the cam track ring. More particularly, the first protrusion 207A is installed within the first slot 173A, the second protrusion 207B is installed within the second slot 173B and the third protrusion 207C is installed within the third slot 173C. A base retainer 211 is located near the second end 201 or may define the second end 201 of the clamp body 197. The base retaining member 211 is an enlargement of the clamp body 197 that is shaped complimentary to the bracket 233 and/or a portion of retaining region 187 formed in the cam track ring 163. As such, the base member 211 fits within the bracket 233 in or above the retaining region 187 on the cam track ring 163 to retain the second end 201 in a fixed position. The lower end 214 of the retaining member 211 fits within the retaining region 187. Thus, when the second end 201 of the C-clamp 113 is fixed in a position, rotation of the cam track ring 163 causes the protrusions 207 to slide within the respective slots 173 to cause the first end 199 to approach the second end 201 as the split ring C-clamp 113 is moved from its unlocked position to its locked and sealed position. The first end may either contact the base retaining member 211 or the second end 201. Thus, it is to be understood that the clamp body 197 is made from a material that retains its shape and configuration when the clamp body 197 is unstressed but is able to flexibly move to a closed position to reduce the diameter of the central aperture 213 that is defined by the vertical wall 205. The central aperture 213 is in open communication with the opening 209 of the clamp body 197 when the split ring C-clamp 113 is unlocked. However, it is to be understood that the opening 209 is closed and eliminated when the clamp body 197 is moved to the locked position.

The clamp seal 195 is a generally C-shaped body formed from a rubber or polymeric material that is able to form a seal when contacted against the hose 144 of the vacuum. The body of the clamp seal that is formed from this rubber or polymeric material may have a generally inverted U-shaped configuration defining a channel 215 that extends between a first end 217 and a second end 219 of the body of the clamp seal 195. The inner wall 221 of the generally inverted U-shaped body may have a helical or spiral protrusion 223 that extends radially inward therefrom. The helical or spiral protrusion 223 that extends radially inward from the inner wall 221 is configured to fit within the space between opposing ribs 1002 on the hose 144 when the clamp 113 is moved from the unlocked position to the second locked position.

The clamp seal 195 is installed on the clamp body 197 by placing the clamp seal 195 atop the clamp body and inserting the vertical wall 205 upwardly into the downwardly opened channel 215. In this configuration, the inner wall 221 is positioned inwardly from the vertical wall 205 and the outer wall of the clamp seal 195 is positioned radially outward from the vertical wall 205. The top of the clamp seal 195 rests atop the upper end of the vertical wall 205 on the clamp body 197. In one particular embodiment, the material that forms the body of the clamp seal 195 is a different polymeric material than the material that forms the clamp body 197. The clamp seal 195 operates to reduce its diameter in response to movement of the clamp body 197 as the split ring C-clamp 113 is actuated in the manner previously described.

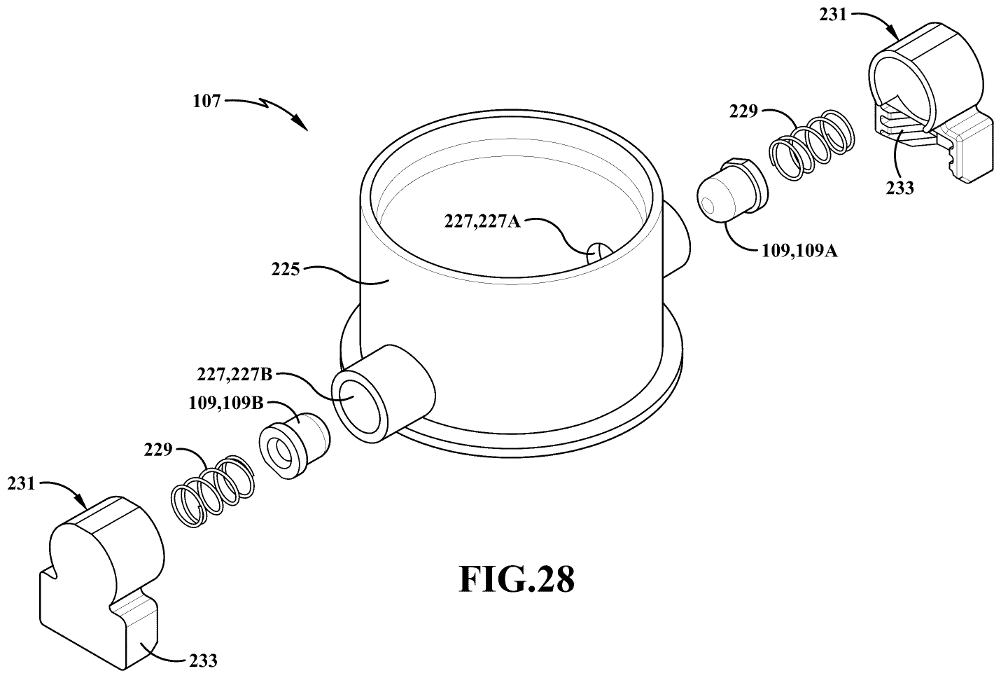

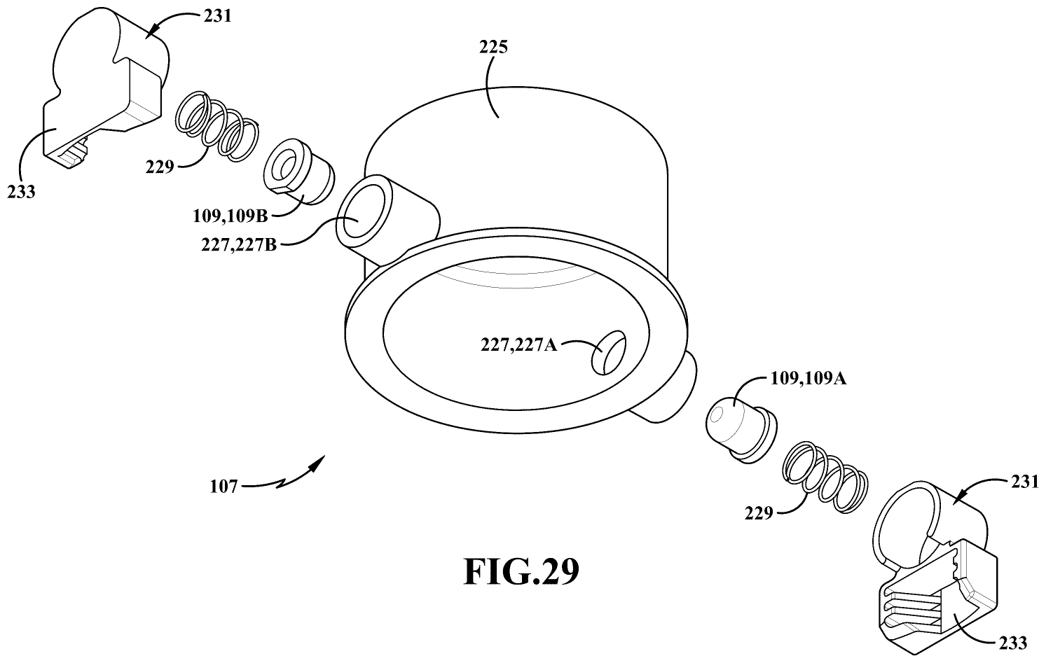

FIG. 28 and FIG. 29 depict the first locking subassembly 107 and its at least one pin 109. The first locking subassembly 107 is similar to that which was discussed in previous embodiments and those embodiments in the incorporated applications. Namely, the first locking subassembly 107 includes a cylindrical wall 225 that has a pair of diametrically opposed apertures 227 that receive the at least one pin 109 therethrough. Namely, a first pin 109A extends through first aperture 227A and a second pin 109B extends through a second aperture 227B. The pins 109 may be biased by springs 229 and retained by members 231. The first locking subassembly 107 operates to engage the hose cuff at the second end of the vacuum hose 144 in the manner previously described such that the pins 109 engage channels formed in the hose cuff. Hose cuff 146 can have the shape, and an associated adapter as taught in the Applicant's U.S. Pat. Nos. 12,016,517; 10,820,763; 11,096,534; 11,019,967; 11,896,187; 12,178,382, and U.S. patents application Ser. Nos. 18/659,812 and 18/962,082, the entirety of each being incorporated by reference as if fully rewritten herein. The manner in which the hose cuff 146 couples to the first locking sub assembly 107 is the same as that which is taught in these incorporated applications, and not repeated for brevity but is to be understood as having the same configuration and operation to extract the hose from the valve box assembly 101.

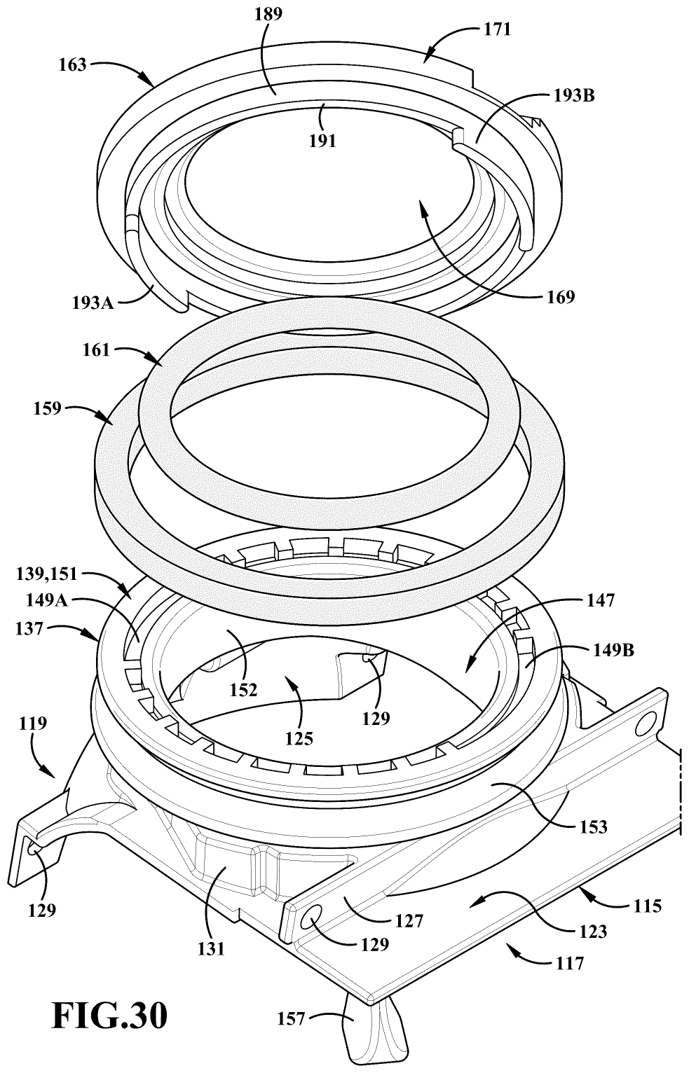

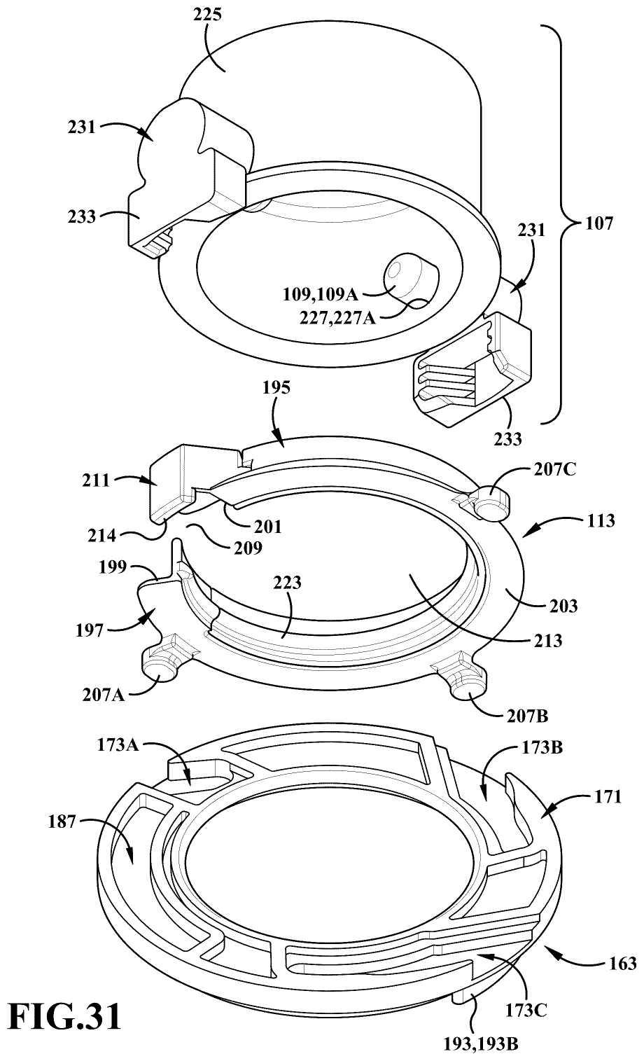

FIG. 30 and FIG. 31 depict the orientation of various components to collectively define the locking assembly 105. The actuator 137 is placed atop the retainer 115. By placing the actuator 137 atop the retainer 115, the handle 157 must be inserted through the central aperture 121 and be positioned below the horizontal portion 123. The lever 157 is positioned towards one side of the retainer 115. In this orientation, the intermediate ledge 153 of the actuator 137 rests atop the annular wall 131 that extends upwardly from the flat horizontal portion 123. The lower surface of the intermediate ledge 153 is able to move or rotate along the top of the annular wall 131. This allows the lever 157 to move from the first side towards the second side of the retainer 115. The orientation of the lever 157 in FIG. 30 is associated with the unlocked position of the second locking subassembly 111. When the lever 157 is moved towards the second side of the retainer 115, the actuator rotates in a counterclockwise movement to move the second locking subassembly 111 to its locked position. As indicated previously, the downward projections 193A, 193B on the cam track ring 163 fit within the corresponding recesses 149A, 149B formed in the top of the actuator 137. The foam ring seal 159 is positioned radially outward from the cylindrical side wall 189 that extends downwardly from the annular body 171 of the cam track ring 163. The O-ring seal 161 is positioned radially inward from the cylindrical side wall 189 (see also FIG. 12).

With continued reference to FIG. 31, the upper surface of the cam track ring 163 is shown to depict the alignment of the first protrusion 207A with the first slot 173A, the alignment of the second protrusion 207B with the second slot 173B and the alignment of the third protrusion 207C with the third slot 173C. Additionally, the alignment of the retaining member 211 is shown with the retaining region 187. The spilt ring C-clamp 113 is positioned atop the cam track ring 163 and is below the lower end of the cylindrical wall 225 on the first locking subassembly 107.

FIG. 32 depicts the split ring C-clamp 113 prior to its installation atop the cam track ring 163. The split ring C-clamp 113 is aligned, when viewed from above, such that the opening 209 is aligned toward the left side. The base member 211 is aligned at the leftmost orientation when viewed from above of the split ring C-clamp 113. The split ring C-clamp 113 is moved atop the cam track ring 163 to align the base member 211 with a bracket 233 on the member 231 above the retaining region 187. In this embodiment, the base member 211 is received within the bracket in a releasably fixed connection to retain the base member 211 between the side walls of the bracket 233. However, in another embodiment it is entirely possible to eliminate the bracket 233 and insert the base member 211 into the retaining region 187 that is defined between walls formed in the upper surface of the cam track ring 163. When the base member 211 is positioned above the bracket 233, the first protrusion 207A is aligned above the first slot 173A, the second protrusion 207B is aligned above the second slot 173B, and the third protrusion 207C is aligned above the third slot 173C. The split ring C-clamp 113 may then be moved downwardly to insert the base member 211 into the space defined by the bracket 233 and the respective protrusions into the respective slots. The lower end 214 of the base member 211 may be in the retaining region 187.

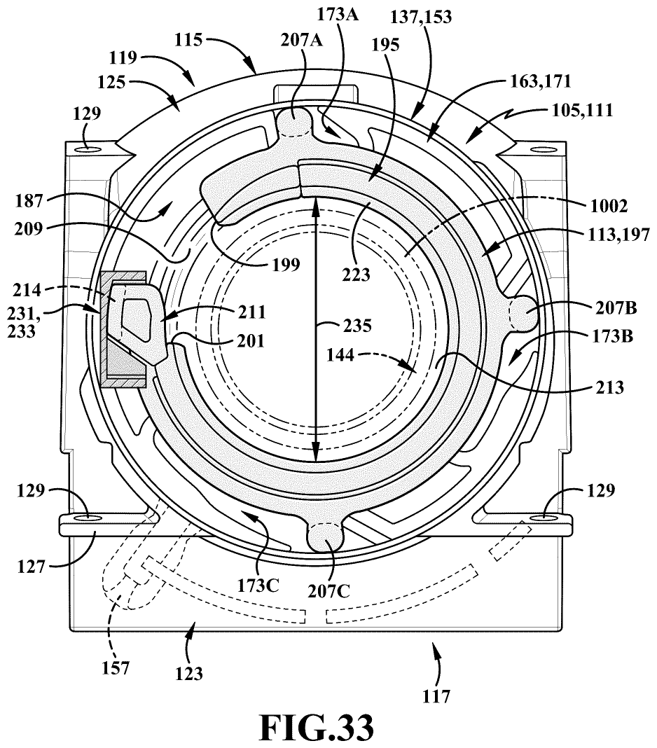

FIG. 33 depicts the installed configuration of the split ring C-clamp 113 on the cam track ring 163. It can be seen that each of the protrusions are within the slots, respectively, near each out end thereof. FIG. 33 depicts the unlocked and open position of the split ring C-clamp 113 for the second locking subassembly 111. In this open and unlocked position, the hose 144 is able to freely extend through the central aperture or central opening of the valve box assembly 101. As indicated previously, the split ring C-clamp is a variable diameter split ring. FIG. 33 represents the open position in which the diameter 235 of the split ring C-clamp 113 is at its maximum. The maximum diameter 235 of the split ring C-clamp 113 is large enough to enable the hose 144 to freely pass through the interior of the valve box assembly without contacting the inner wall or the spiral protrusion 223 which is used to seal the hose in the locked and closed position. This also assists to ensure that any hose sock that surrounds the hose 144 does not bunch as the hose is moved through the locking assembly 105 and valve box assembly 101.

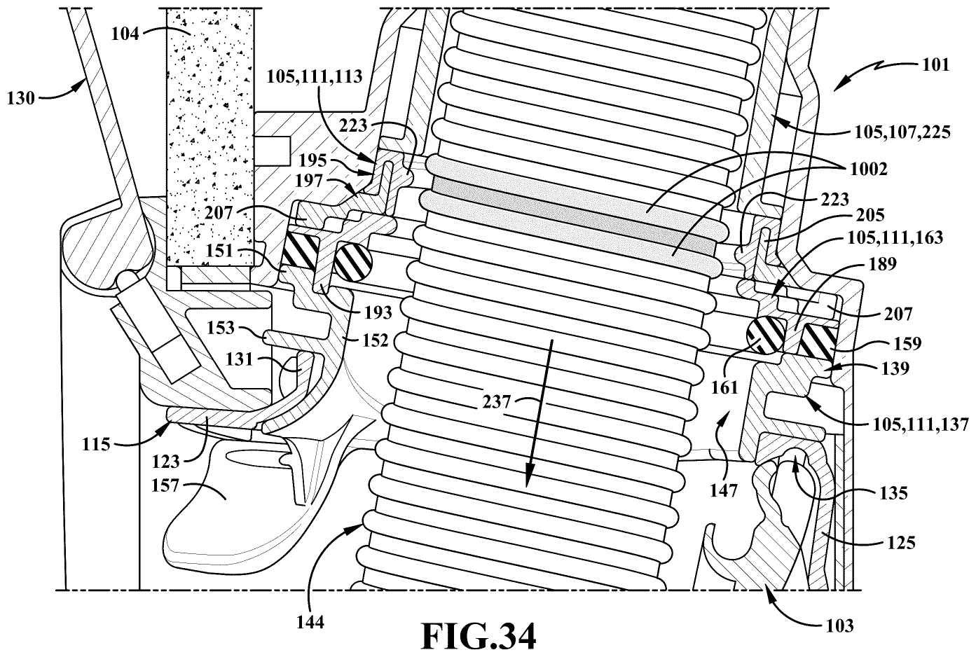

FIG. 34 depicts a further operation of the second locking subassembly 111. The hose 144 is shown as being extracted partially, as indicated by arrow 237 relative to the valve box assembly 101. Notably, the extraction of the hose as indicated by arrow 237 moves a portion of the hose 144 out of the valve box assembly 101 to an intermediate length of the hose (i.e., any position between the ends of the hose). The distance that the hose 144 is pulled out of the valve box assembly 101 is based on a user-selected choice. It has been determined that a user may not always want to couple the hose to the valve box assembly at its end with the hose cuff using the first locking subassembly 107 in the first locked position. The second locking subassembly 111 provides the user with more flexibility and options for selectively locking and sealing the hose 144 to the valve box assembly 101 at any point of the hose intermediate or between the respective ends. During this movement as indicated by arrow 237, the second locking subassembly 111 is in its unlocked and unsealed position. This allows the hose 144 to freely extend out of the valve box assembly 101. Similarly, although arrow 237 represents the extraction of the hose to selectively choose an intermediate length thereof for which the second locking subassembly will seal against the hose, it is to be understood that insertion of the hose into the valve box assembly to shorten the length that extends therefrom is also entirely within the scope of the present disclosure.

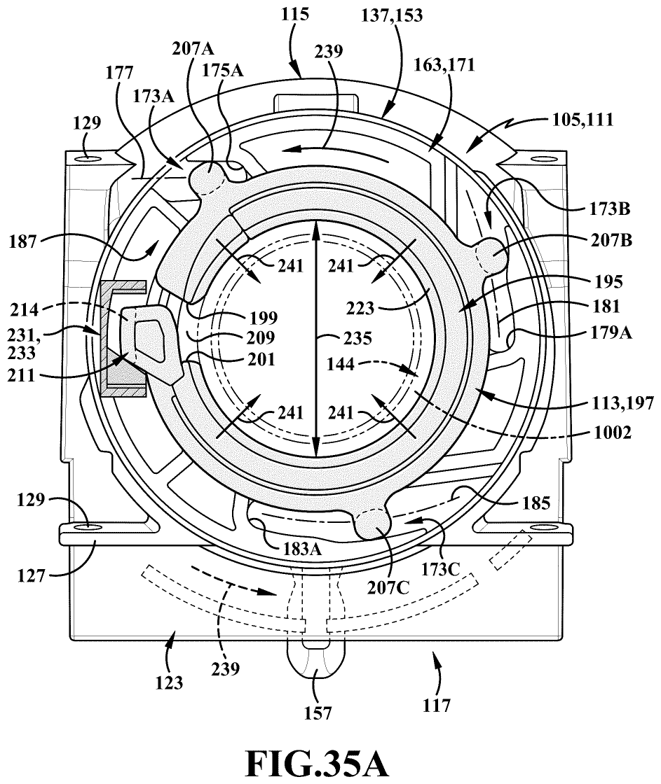

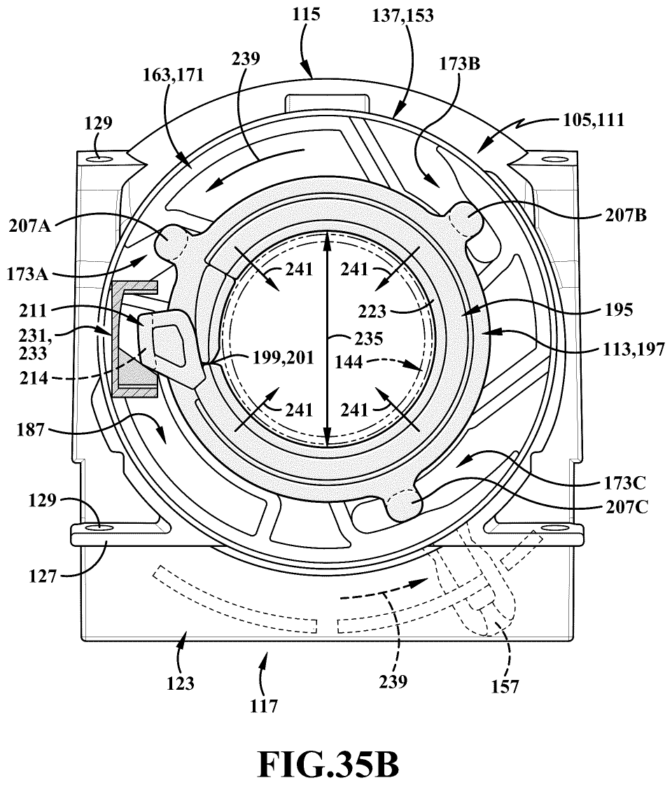

FIG. 35A and FIG. 35B depict the further operation of the second locking subassembly 111 in which it is moved from an unlocked position to a locked and sealed position (i.e., the second locking position of the locking assembly 105). FIG. 35A depicts that the lever 157 is moved in the direction indicated by arrow 239. The rotation of lever 157 causes the actuator 137 to rotate about the center axis in the middle of the central aperture 147 of the actuator 137. Stated otherwise, the rotational axis about which the lever 157 rotates is concentric and coaxial with the center of the valve box assembly, the center of the hose 144, the center of the foam ring 159, the center of the O-ring 161, the center of the cam track ring 163, and the center of the split ring C-clamp 113. By coaxially aligning and causing the axis of rotation to be concentric with all these center points, the second locking subassembly 111 is able to more efficiently provide a secure clamp and seal with the exterior surface of the hose 144. This is distinct from prior attempts to create a hose clamp that used a conventional pipe band clamp style having a lever that pivoted about an axis that was eccentric or noncoaxial with the central axis of the hose or the seal (c.f., U.S. Pat. No. 7,010,829).

With continued reference to FIG. 35A, as the lever 157 is moved in the direction of arrow 239, this causes the actuator 137 to rotate in the same direction. The shown example indicates that arrow 239 is a counterclockwise rotation in which the lever 157 is moved from the left side of the valve box assembly 101 toward the right side of the valve box assembly 101. However, obviously it is to be understood that these rotational directions could be reversed if suited for the application specific needs of the valve box assembly 101.

As the actuator 137 is rotated toward the clamped and sealed position associated with the second locked position of the locking assembly 105, the slots 173 provide a camming action to interact with the protrusions 207 on the split ring C-clamp 113. Namely, the first protrusion 207A slides along axis 177 in the first slot 173A towards the inner closed end 175A. Similarly, the second protrusion 207B slides along the axis 181 within the second slot 173B toward the inner closed end 179A. Additionally, the third protrusion 207C slides along axis 185 within the third slot 173C towards the inner closed end 183A. The camming action of the protrusions 207 through the respective slots 173 causes the split ring C-clamp 113 to begin to reduce its diameter 235 by cinching or moving inward towards the center of the central aperture 213 as indicated by arrows 241. The length of the opening 209 begins to reduce by bringing the free first end 199 of the body 197 toward the second end 201 of the body 197 that is in a relatively or generally fixed in position (relative to perimeter or circumferential movement) via the base member 211. The base member 211 may slightly move in the radially directly such that the lower end 214 of base member 211 is bound between the walls defining retaining region 187.

FIG. 35 depicts the lever 157 having been fully rotated to the closed, locked and sealed second locking position in which the diameter 235 of the split ring C-clamp 113 is reduced to its minimum dimension after having moved inwardly toward the center as indicated by arrows 241. The opening 209 is closed off when the first end 199 contact the second end 201 of the clamp body 197. As the split ring C-clamp 113 is reduced in diameter 235, the seal 195 that rests atop the clamp body 197 is also narrowed in diameter.

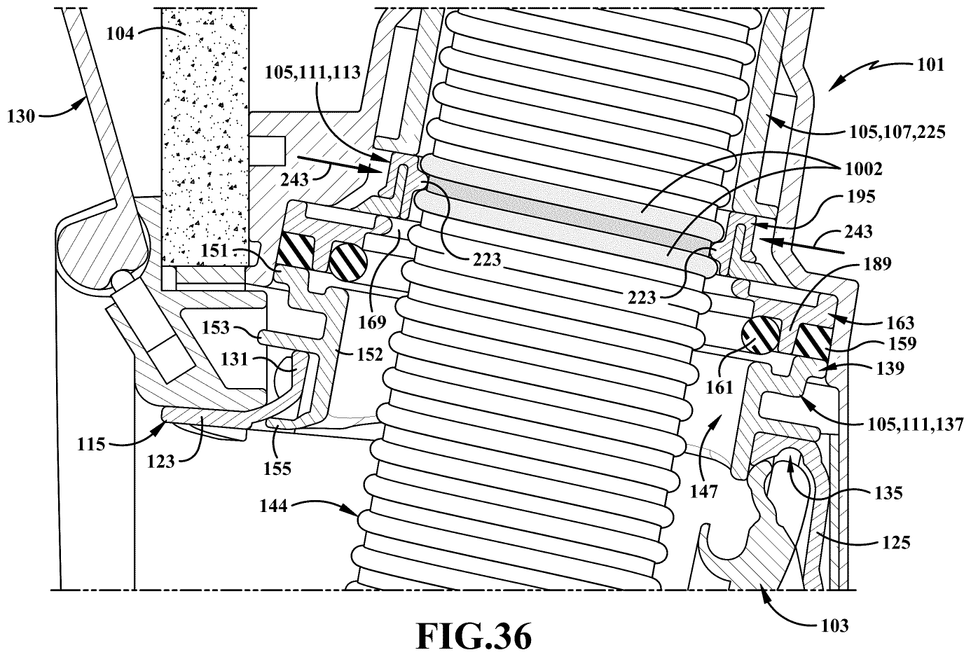

As indicated in FIG. 36, when the second locking subassembly 111 is in its locked and sealed position, the seal 195 on the clamp body 197 is moved inward as indicated by arrows 243. The helical or spiral protrusion 223 is sealed against the hose 144 in a space defined between two adjacent ribs 1002. The seal secures the hose and prevents air from moving into the vacuum conduit and instead causes the vacuum suctioning forces to extend through the hose 144 in order to pick up debris.

The valve box assembly 101 of the present disclosure may additionally include one or more sensors to sense or gather data pertaining to the surrounding environment or operation of the valve box assembly 101 or the central vacuum system. Some exemplary sensors capable of being electronically coupled with the valve box assembly 101 of the present disclosure (either directly connected to the valve box assembly 101 of the present disclosure or remotely connected thereto, or coupled to other parts of the central vacuum system) may include but are not limited to: accelerometers sensing accelerations experienced during rotation, translation, velocity/speed, location traveled, elevation gained; gyroscopes sensing movements during angular orientation and/or rotation, and rotation; altimeters sensing barometric pressure, altitude change, terrain climbed, local pressure changes, submersion in liquid; impellers measuring the amount of fluid passing thereby; global positioning sensors sensing location, elevation, distance traveled, velocity/speed; audio sensors sensing local environmental sound levels, or voice detection; photo/light sensors sensing ambient light intensity, ambient, day/night, UV exposure; TV/IR sensors sensing light wavelength; temperature sensors sensing machine or motor temperature, ambient air temperature, and environmental temperature; radar sensors; lidar sensors; ultrasonic sensors; magnetic sensors, image sensors; and moisture sensors sensing surrounding or internal moisture levels.

If sensors are utilized to gather data relating to the valve box assembly 101 or the central vacuum system of the present disclosure, then sensed data may be evaluated and processed with artificial intelligence (AI). Analyzing data gathered from sensors using artificial intelligence involves the process of extracting meaningful insights and patterns from raw sensor data to produce refined and actionable results. Raw data is gathered from various sensors, for example those which have been identified herein or others, capturing relevant information based on the intended analysis. This data is then preprocessed to clean, organize, and structure it for effective analysis. Features that represent key characteristics or attributes of the data are extracted. These features serve as inputs for AI algorithms, encapsulating relevant information essential for the analysis. A suitable AI model, such as machine learning or deep learning (regardless of whether it is supervised or unsupervised), is chosen based on the nature of the data and the desired analysis outcome. The model is then trained using labeled or unlabeled data to learn the underlying patterns and relationships. The model is fine-tuned and optimized to enhance its performance and accuracy. This process involves adjusting parameters, architectures, and algorithms to achieve better results. The trained model is used to make predictions or inferences on new, unseen data. The model processes the extracted features and generates refined output based on the patterns it has learned during training. The results produced by the AI model are refined through post-processing techniques to ensure accuracy and relevance. These refined results are then interpreted to extract meaningful insights and derive actionable conclusions. Feedback from the refined results is used to improve the AI model iteratively. The process involves incorporating new data, adjusting the model, and enhancing the analysis based on real-world feedback and evolving requirements. Further, AI results can be used to alter the operation of the device, assembly, or system of the present disclosure based on feedback. For example, AI feedback can be used to improve the efficiency of the device, assembly, or system of the present disclosure by responding to predicted changes in the environment or predicted changes to the device, assembly, or system of the present disclosure more quickly than if only sensed by one or more of the sensors.

A sensor model may be employed, once trained, in the valve box assembly 101 or central vacuum system of the present disclosure. In one embodiment, the valve box assembly 101 or the central vacuum system of the present disclosure can be used to teach a sensor model to predict sensor data for a specific scenario (i.e., turn on or off in response to sensed conditions or increase/decrease vacuum suction in response to sensed conditions). Alternatively, sensor models can be utilized to generate the data to train the AI. The sensor model can be trained for any type of sensor, such as those types of sensors described above, and/or other sensor types. The elements described herein may be implemented as discrete or distributed components in any suitable combination and location. The various functions described herein may be conducted by hardware, firmware, and/or software. For example, a processor may perform various functions by executing instructions stored in memory.

The AI model and/or sensor model can include a deep neural network (DNN), convolutional neural network (CNN), another neural network (NN) or the like and can support generative learning. For example, the sensor model can include a generative adversarial network (GAN), a variational autoencoder (VAE), and/or another type of DNN, CNN, NN or machine learning model (e.g., natural language processing (NLP)). Generally, the sensor model can accept some encoded representation of a scene as input using any number of data structures and/or channels (e.g., concatenated vectors, matrices, tensors, images, etc.).

In a particular embodiment, the valve box assembly 101 of the present disclosure can use the sensors to acquire a representation of the real-world environment (e.g., a physical environment in the central vacuum system) at a given point in time. Data from these sensors may be used to generate a representation of a scene or scenario, which may then be used to teach a sensor model. For example, a representation of a scene can be derived from sensor data, properties of objects in the scene or surrounding environment such as positions or dimensions (e.g., vacuum pressure forces), classification data identifying objects in the scene or surrounding environment or that are being moved (i.e., suction) through the vacuum system, properties or classification data of components of the valve box assembly 101 of the present disclosure, or some combination thereof. Generally, the sensor model learns to predict sensor data from a representation of the scene, environment or operation of the valve box assembly 101 of the present disclosure.

The sensor model architecture can be selected to fit the shape of the desired input and output data. Examples of architectures (e.g., DNNs) include, but are not limited to, perceptron, feed-forward, radial basis, deep feed-forward, recurrent, long/short term memory, gated recurrent unit, autoencoder, variational autoencoder, convolutional, deconvolutional, and generative adversarial. Some DNN architectures, such as a GAN, can include a convolutional neural network (CNN) that accepts and evaluates an input image and may include multiple input channels, which may be used to accept and evaluate multiple input images and/or input vectors.

In one embodiment, training data for the sensor model may be generated using real-world (e.g., physical environment) data. To collect real-world training data, the valve box assembly 101 of the present disclosure may collect sensor data by fusing sensors as the vehicle traverses a real-world environment. The sensors of the valve box assembly 101 of the present disclosure may include, for example, one or more accelerometer(s), gyroscope(s), magnetic compass(es), magnetometer(s), etc., ego-motion sensors, microphones, stereo cameras, wide-view cameras (e.g., fisheye cameras), infrared cameras, surround cameras (e.g., 360 degree cameras), long-range and/or mid-range cameras, speed sensors (e.g., for measuring the speed of the air moving through the hose), vibration sensors, and/or other sensor types.

In another embodiment, training data for the sensor model is generated based on simulated or virtual environments. The training data may then be used to train the sensor model for use in real-world applications, e.g., to control the operation of the valve box assembly 101 or central vacuum system of the present disclosure. The training data may be derived to fit the shape of the input and output data for the sensor model, which may depend on the architecture of the sensor model. For example, sensor data may be used to encode an input scene, input parameters, and/or ground truth sensor data using different data structures and/or channels (e.g., concatenated vectors, matrices, tensors, images, etc.).

Hyperparameters are settings that govern the training process and behavior of AI models. Exemplary hyperparameters include learning rate, batch size, and regularization parameters. Adjusting these hyperparameters can impact the model's convergence, stability, and generalization capabilities. For example, a higher learning rate may speed up training but risk overshooting optimal solutions, while a lower learning rate ensures precise adjustments but may slow down the process. Similarly, batch size affects gradient estimation and memory usage, influencing the model's ability to learn effectively from the data. The number and type of layers in an AI model define its complexity and capacity to learn from data. Layers can be categorized into input, hidden, and output layers, each serving a specific function. Input layers receive raw data, hidden layers process and extract features, and output layers generate predictions. The depth of the model, determined by the number of hidden layers, allows it to capture intricate patterns and relationships in the data. For instance, DNNs with multiple hidden layers can learn complex representations, while shallow networks may be more suitable for simpler tasks. The architecture of an AI model refers to its overall structure and design, encompassing the arrangement of layers and connections. Different architectures may be tailored to specific types of data and tasks. For example, CNNs are well-suited for image data, leveraging convolutional layers to detect spatial features. Recurrent neural networks (RNNs) and their variants, such as long short-term memory (LSTM) networks, excel in handling sequential data by maintaining temporal dependencies. GANs and VAEs are used for generative tasks, creating new data samples based on learned patterns. The selection of hyperparameters, layers, and architectures directly influences the type of protocol or architecture employed in the AI model. For instance, a protocol designed for real-time data analysis may prioritize low-latency architectures with optimized hyperparameters for rapid inference. Conversely, a protocol for offline batch processing may focus on deep architectures with extensive layers to achieve high accuracy. The choice of architecture also affects the model's ability to handle different data modalities, such as images, text, or sensor data, ensuring that the protocol aligns with the specific requirements of the task.

The valve box assembly 101 or central vacuum system of the present disclosure may include hardware, software and/or firmware responsible for managing the sensor data generated by the sensors. The autonomous hardware, software, and/or firmware being executed may manage different environments using one or more maps (e.g., 3D maps), positioning component(s), and the like. The autonomous hardware, software, and/or firmware may also include components to plan, control, and generally manage the valve box assembly 101 or central vacuum system of the present disclosure. In one example, the hardware, software, and/or firmware can be installed in and used to control the valve box assembly 101 or central vacuum system of the present disclosure through the environment based on the sensor data, one or more machine learning models (e.g., neural networks), and the like. A training system may use the training data to train the sensor model to predict virtual sensor data for a given scene, environment, or operation of a component.

The valve box assembly 101 or central vacuum system of the present disclosure may include wireless communication logic coupled to sensors on the valve box assembly 101. The sensors gather data and provide the data to the wireless communication logic. Then, the wireless communication logic may transmit the data gathered from the sensors to a remote device. Thus, the wireless communication logic may be part of a broader communication system, in which one or several devices, assemblies, or systems of the present disclosure may be networked together to report alerts and, more generally, to be accessed and controlled remotely. Depending on the types of transceivers installed in the device, assembly, or system of the present disclosure, the system may use a variety of protocols (e.g., Wi-Fi®, ZigBee®, MIWI, BLUETOOTH®) for communication. In one example, each of the devices, assemblies, or systems of the present disclosure may have its own IP address and may communicate directly with a router or gateway. This would typically be the case if the communication protocol is Wi-Fi®. (Wi-Fi® is a registered trademark of Wi-Fi Alliance of Austin, TX, USA; ZigBee® is a registered trademark of ZigBee Alliance of Davis, CA, USA; and BLUETOOTH® is a registered trademark of Bluetooth Sig, Inc. of Kirkland, WA, USA).

The system that receives and processes signals from the valve box assembly 101 or central vacuum system of the present disclosure may differ from embodiment to embodiment. In one embodiment, alerts and signals from the valve box assembly 101 or central vacuum system of the present disclosure are sent through an e-mail or simple message service (SMS; text message) gateway so that they can be sent as e-mails or SMS text messages to a remote device, such as a smartphone, laptop, or tablet computer, monitored by a responsible individual, group of individuals, or department, such as a maintenance department or a home owner. Thus, if a particular valve box assembly 101 or central vacuum system of the present disclosure creates an alert because of a data point gathered by one or more sensors, that alert can be sent, in e-mail or SMS form, directly to the individual responsible for fixing it. Of course, e-mail and SMS are only two examples of communication methods that may be used; in other embodiments, different forms of communication may be used.

In other embodiments, alerts and other data from the sensors on the valve box assembly 101 or central vacuum system of the present disclosure may also be sent to a work tracking system that allows the individual, or the organization for which he or she works, to track the status of the various alerts that are received, to schedule particular workers to repair a particular valve box assembly 101 or central vacuum system of the present disclosure, and to track the status of those repair jobs. A work tracking system would typically be a server, such as a Web server, which provides an interface individuals and organizations can use, typically through the communication network. In addition to its work tracking functions, the work tracker may allow broader data logging and analysis functions. For example, operational data may be calculated from the data collected by the sensors on the valve box assembly 101 or central vacuum system of the present disclosure, and the system may be able to provide aggregate machine operational data for a valve box assembly 101 or central vacuum system of the present disclosure or group of devices, assemblies, or systems of the present disclosure.

As described herein, aspects of the present disclosure may include one or more electrical, pneumatic, hydraulic, or other similar secondary components and/or systems therein. The present disclosure is therefore contemplated and will be understood to include any necessary operational components thereof. For example, electrical components will be understood to include any suitable and necessary wiring, fuses, or the like for normal operation thereof. Similarly, any pneumatic systems provided may include any secondary or peripheral components such as air hoses, compressors, motors, valves, meters, or the like. It will be further understood that any connections between various components not explicitly described herein may be made through any suitable means including mechanical fasteners, or more permanent attachment means, such as welding or the like. Alternatively, where feasible and/or desirable, various components of the present disclosure may be integrally formed as a single unit.

Unless explicitly stated that a particular shape or configuration of a component is mandatory, any of the elements, components, or structures discussed herein may take the form of any shape. Thus, although the figures depict the various elements, components, or structures of the present disclosure according to one or more exemplary embodiments, it is to be understood that any other geometric configuration of that element, component, or structure is entirely possible. For example, instead of the markers being circular dots, the C-shaped split ring clamp 113 can be semi-circular triangular, rectangular or square, pentagonal, hexagonal, heptagonal, octagonal, decagonal, dodecagonal, diamond shaped or another parallelogram, trapezoidal, star-shaped, oval, ovoid, lines or lined, teardrop-shaped, cross-shaped, donut-shaped, heart-shaped, arrow-shaped, crescent-shaped, any letter shape (i.e., A-shaped, B-shaped, C-shaped, D-shaped, E-shaped, F-shaped, G-shaped, H-shaped, I-shaped, J-shaped, K-shaped, L-shaped, M-shaped, N-shaped, O-shaped, P-shaped, Q-shaped, R-shaped, S-shaped, T-shaped, U-shaped, V-shaped, W-shaped, X-shaped, Y-shaped, or Z-shaped), or any other type of regular or irregular, symmetrical or asymmetrical configuration.

Various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Any flowchart and/or block diagrams in the Figures illustrate some exemplary architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

For example, although the valve box assembly 101 of the present disclosure is described as a complete unit within the present disclosure, it is to be understood that some of the components or features detailed herein can be supplied as a retrofit kit. This approach enables the provision of only certain parts necessary to upgrade a legacy device to the specifications of valve box assembly 101 of the present disclosure. Essentially, instead of requiring the replacement of the entire device, the retrofit kit allows for the selective enhancement of specific components. This could allow a user or operator to efficiently upgrade its/their existing legacy devices, systems, or assemblies to achieve the performance and functionality of the valve box assembly 101 of the present disclosure without a full replacement. In the event that a component or portion of the valve box assembly 101 of the present disclosure is provided as part of a retrofit kit, those components may be integrated into legacy devices, systems or assemblies to upgrade the same. By facilitating partial upgrades, it addresses the need for continuous improvement and adaptation in dynamic environments where complete replacement might be neither feasible nor necessary. As a result, a user or operator would be able to make an enhancement, thereby extending the lifecycle, optimizing, or improving those legacy devices, systems, or assemblies.

All definitions, as defined and used herein, should be understood to control over dictionary definitions, definitions in documents incorporated by reference, and/or ordinary meanings of the defined terms.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc. As another example, “at least one of: A, B, or B” is intended to cover A, B, C, A-B, A-C, B-C, and A-B-C, as well as any combination with multiple of the same item.

While components of the present disclosure are described herein in relation to each other, it is possible for one of the components disclosed herein to include inventive subject matter, if claimed alone or used alone. In keeping with the above example, if the disclosed embodiments teach the features of A and B, then there may be inventive subject matter in the combination of A and B, A alone, or B alone, unless otherwise stated herein.

As used herein in the specification and in the claims, the term “effecting” or a phrase or claim element beginning with the term “effecting” should be understood to mean to cause something to happen or to bring something about. For example, effecting an event to occur may be caused by actions of a first party even though a second party actually performed the event or had the event occur to the second party. Stated otherwise, effecting refers to one party giving another party the tools, objects, or resources to cause an event to occur. Thus, in this example a claim element of “effecting an event to occur” would mean that a first party is giving a second party the tools or resources needed for the second party to perform the event, however the affirmative single action is the responsibility of the first party to provide the tools or resources to cause said event to occur.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “above”, “behind”, “in front of”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal”, “lateral”, “transverse”, “longitudinal”, and the like are used herein for the purpose of explanation only unless specifically indicated otherwise.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed herein could be termed a second feature/element, and similarly, a second feature/element discussed herein could be termed a first feature/element without departing from the teachings of the present disclosure.

An embodiment is an implementation or example of the present disclosure. Reference in the specification to “an embodiment,” “one embodiment,” “some embodiments,” “one particular embodiment,” “an exemplary embodiment,” or “other embodiments,” or the like, means that a particular feature, structure, or characteristic described in connection with the embodiments is included in at least some embodiments, but not necessarily all embodiments, of the invention. The various appearances “an embodiment,” “one embodiment,” “some embodiments,” “one particular embodiment,” “an exemplary embodiment,” or “other embodiments,” or the like, are not necessarily all referring to the same embodiments. Furthermore, the use of any and all examples or exemplary language (“e.g.,” “such as,” or the like) is intended merely to better illustrate or illuminate the embodiments and does not pose a limitation on the scope of that or those embodiments. No language in this specification should be construed as indicating any unclaimed element as essential to the practice of the disclosed embodiment.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element or “another” element, that does not preclude there being more than one of the additional element or the another element.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical range recited herein is intended to include all sub-ranges subsumed therein. Further, recitation of ranges of values herein are not intended to be limiting, referring instead individually to any and all values falling within that range, unless otherwise indicated herein, and each separate value within such range is incorporated into the specification as if it were individually recited herein.

Additionally, the method of performing the present disclosure may occur in a sequence different than those described herein. Accordingly, no sequence of the method should be read as a limitation unless explicitly stated. It is recognizable that performing some of the steps of the method in a different order could achieve a similar result.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

To the extent that the present disclosure has utilized the term “invention” in various titles or sections of this specification, or in the context of those sections, this term has been included as required by the formatting requirements of word document submissions (i.e., docx submissions) pursuant the guidelines/requirements of the United States Patent and Trademark Office and shall not, in any manner, be considered a disavowal of any subject matter.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of various embodiments of the disclosure are examples and the disclosure is not limited to the exact details shown or described.

What is claimed:

1. A valve box assembly of a central vacuum system having a locking assembly to selectively secure a vacuum hose at various lengths relative to the valve box assembly of the central vacuum system, wherein the locking assembly comprises:
a first locking subassembly comprising at least one moveable pin;
a different second locking subassembly comprising a variable diameter split ring clamp;
wherein when the first locking subassembly and the different second locking subassembly are both in an unlocked position, the vacuum hose freely extends and retracts relative to the valve box assembly;
wherein when the first locking subassembly is in a first locked position, the at least one moveable pin is coupled to an end of the vacuum hose and locks the vacuum hose relative to the valve box assembly;
wherein when the different second locking subassembly is in a second locked position, the variable diameter split ring clamp couples to an intermediate length of the vacuum hose and locks the vacuum hose relative to the valve box assembly;
wherein prior to moving the locking assembly to the second locked position, the vacuum hose is moved into the valve box assembly to alter a length of the vacuum hose that extends from the valve box assembly; and
wherein the length of the vacuum hose that extends from the valve box assembly in the second locked position is shorter than the length of the vacuum hose that extends from the valve box assembly in the first locked position.

2. The valve box assembly of claim 1, wherein the different second locking subassembly further comprises:
an annular member that defines at least one slot; and
at least one boss on the variable diameter split ring clamp, wherein the at least one boss is disposed within the at least one slot.

3. The valve box assembly of claim 2, wherein the at least one boss extends from a perimeter of the variable diameter split ring clamp.

4. The valve box assembly of claim 2, wherein the at least one boss moves within the at least one slot in response to a rotation of the annular member that imparts a cam action to the variable diameter split ring clamp.

5. The valve box assembly of claim 2, wherein the different second locking subassembly further comprises:
three slots defined in the annular flange, wherein the at least one slot is one of the three slots;
three bosses extending from a perimeter of the variable diameter split ring clamp, wherein the at least one boss is one of the three bosses; and
wherein the three bosses are disposed within the three slots, respectively.

6. The valve box assembly of claim 2, wherein the different second locking subassembly further comprises:
a lever that is coupled with the annular flange, wherein rotation of the lever causes the rotation of the annular flange.

7. The valve box assembly of claim 6, wherein rotation of the annular flange causes the at least one boss to slide in the at least one slot, wherein movement of the boss causes the variable diameter split ring clamp to vary its diameter.

8. The valve box assembly of claim 2, wherein the variable diameter split ring clamp has a maximum diameter when a lever coupled to the annular flange is in an unlocked position, wherein movement of the lever to the second locked position causes the diameter of the variable diameter split ring clamp to be reduced, wherein the reduced diameter causes the variable diameter split ring clamp to lock onto the hose.

9. The valve box assembly of claim 2, wherein the different second locking subassembly further comprises:
an actuator that is annular in shape, wherein a lever is integrally formed as part of the actuator and extends radially outward therefrom.

10. The valve box assembly of claim 9, wherein the actuator defines at least one recess that is arcuate in shape.

11. The valve box assembly of claim 10, wherein the different second locking subassembly further comprises:
a downward projection that extends from the annular flange, wherein the downward projection is received within the at least one recess.

12. The valve box assembly of claim 9, wherein the actuator is coupled with the annular flange to cause the actuator and the annular flange to rotate in unison in response to movement of the lever.

13. The valve box assembly of claim 12, wherein rotation of the annular flange causes the at least one boss to slide in the at least one slot to thereby vary the diameter of the variable diameter split ring clamp, wherein movement of the handle from a first position to a second position causes the different second locking subassembly to move from the unlocked position to the second locked position, wherein the diameter of the split ring is reduced in the second locked position and the diameter of the split ring clamp is maximum in the unlocked position.

14. The valve box assembly of claim 1, wherein the different second locking subassembly further comprises:
a lever that is rotatable about a central axis that is concentric and coaxial with a center axis of the vacuum hose within the valve box assembly.

15. The valve box assembly of claim 14, wherein a rotational action of the lever is operatively coupled to the variable diameter split ring clamp such that rotation of the lever causes the second locking subassembly to move from an unlocked position to the second locked position to couple to the intermediate length of the vacuum hose and not the end of the vacuum hose.

16. The valve box assembly of claim 1, wherein the different second locking subassembly further comprises:
a spiral projection extending radially inward on the split ring clamp, wherein the spiral projection is positioned between ribs on the hose when the second locking subassembly is in the second locked position.

17. The valve box assembly of claim 1, wherein the variable diameter split ring clamp comprises:
a C-shaped clamp body; and
a C-shaped seal that is coupled to the C-shaped clamp body.

18. The valve box assembly of claim 1, wherein the variable diameter split ring clamp comprises:
a first end and a second end defining a space therebetween when the variable diameter split ring clamp is unstressed in the unlocked position; and
a base that defines the second end that remains in a fixed position as the diameter of the split ring clamp is varied.

19. A locking subassembly for a valve box assembly in a central vacuum system, the locking subassembly comprising:
a cam track that defines at least one slot in an upper end thereof;
a variable diameter split ring C-shaped clamp including at least one boss that is received within the at least one slot of the cam track; and
wherein the diameter of the variable diameter split ring C-shaped clamp is varied in response to a cam action imparted by the at least one slot when the cam track is rotated about an axis.

20. The locking subassembly of claim 19, further comprising:
an actuator that is generally annular in shape, wherein the actuator includes a lever at a lower end thereof and defines at least one recess in an upper end thereof;
wherein the cam track is a cam track ring that is generally annular in shape, wherein the cam track ring includes at least one downward projection that is received in the at least one recess of the actuator; and
wherein the at least one boss on the variable diameter split ring C-clamp projects radially outward from a perimeter thereof.
